(19) United States
(12) Patent Application Publication
(10) Pub. No.: US 2010/0326726 A1
(43) Pub. Date: Dec. 30, 2010

(54) SOLDER JOINT STRUCTURE, ELECTRONIC DEVICE USING THE SAME, AND SOLDER BONDING METHOD

(75) Inventors: Hisao Tanaka, Chiba (JP); Satoshi Emoto, Kawasaki (JP); Kenichi Nashirozawa, Kawasaki (JP); Nana Matsushima, Kawasaki (JP); Takumi Masuyama, Kawasaki (JP)

Correspondence Address: KRATZ, QUINTOS & HANSON, LLP, 1420 K Street, N.W., 4th Floor, WASHINGTON, DC, 20005, US

(73) Assignee: FUJITSU LIMITED, Kawasaki (JP)

(21) Appl. No.: 12/818,542

(22) Filed: Jun. 18, 2010

(30) Foreign Application Priority Data
Jun. 24, 2009 (JP) 2009-149532

(51) Int. Cl. H01R 4/02

(52) U.S. Cl. 174/84 R

(57) ABSTRACT

A solder joint structure include: a first terminal portion including a plurality of first terminal conductors adjacent to each other; a second terminal portion arranged opposite to the first terminal portion and including a plurality of second terminal conductors which are joined to the first terminal conductors; solders electrically connecting the first terminal conductors and the second terminal conductors; and member for suppressing flow of the solders.

### CROSS REFERENCE TO RELATED APPLICATION

This application is based upon and claims the benefit of priority from the prior Japanese Patent Application NO. 2009-149532 filed on Jun. 24, 2009, the entire contents of which are incorporated herein by reference.

1. Field

The embodiments discussed herein are related to a solder joint structure, an electronic device using the solder joint structure, and a solder bonding method.

2. Background

Electrical conduction with soldering is established in various portions of electronic devices. For example, a first terminal portion including a first terminal conductor and a second terminal portion including a second terminal conductor, which is to be joined to the first terminal conductor, are arranged in opposite relation, and electrical conduction between the first terminal conductor and the second terminal conductor is established by soldering. In some cases, the first terminal conductor is disposed plural in adjacent relation. A technique for joining the first terminal conductor and the second terminal conductor to each other by soldering is disclosed as one example of related art. When the first terminal conductor and the second terminal conductor are joined to each other, a solder is previously pre-coated on one of those terminal conductors and pressure bonding is performed on the first terminal conductor and the second terminal conductor which are arranged in opposite relation. In the pressure bonding, the first terminal conductor and the second terminal conductor are joined to each other by melting the solder while heat and pressure are applied to the solder.

### [Patent Document 1]

### Japanese Laid-open Patent Publication No. 2008-300594

Recently, there has been a tendency toward an increase in the number of terminal conductors which are arranged adjacent to each other. An increase in the number of terminal conductors arranged adjacent to each other increases a risk of short-circuiting between the terminals. In particular, the short-circuiting is more apt to occur with the molten solders under such design conditions that a reduction of a solder joint area and a finer pitch of the terminals are demanded in consideration of downsizing of the electronic device itself, matching with electronic parts mounted on the electronic device, etc. The solder needs to be supplied in a proper amount in order to obtain a satisfactory solder joint while preventing the short-circuiting between the terminals. In some cases, however, a difficulty arises in controlling the amount of solder supplied.

### SUMMARY

According to one aspect of the embodiments, there is provided a solder joint structure includes: a first terminal portion including a plurality of first terminal conductors adjacent to each other, a second terminal portion arranged opposite to the first terminal portion and including a plurality of second terminal conductors which are joined to the first terminal conductors, solders electrically connecting the first terminal conductors and the second terminal conductors, and means for suppressing flow of the solders.

The object and advantages of the embodiments will be realized and attained by means of the elements and combinations particularly pointed out in the claims.

It is to be understood that both the foregoing general description and the following detailed description and are exemplary and explanatory and are not restrictive of the embodiments, as claimed.

### BRIEF DESCRIPTION OF DRAWINGS

FIG. 1 is an explanatory view illustrating an internal structure of a magnetic disk device to which a solder joint structure according to a first embodiment is applied.

FIG. 2 is an explanatory view illustrating a rotary actuator in the magnetic disk device, the rotary actuator being taken out from the magnetic disk device and illustrated in a partly omitted state.

FIGS. 3A and 3B are respectively an explanatory view illustrating an FPC (Flexible Print Circuit) in the rotary actuator, the FPC being taken out from the rotary actuator, and an enlarged view of an FPC terminal portion.

FIGS. 4A and 4B are each an explanatory view illustrating a head gimbal assembly in the rotary actuator, the head gimbal assembly being taken out from the rotary actuator.

FIG. 5 is an explanatory view illustrating a suspension terminal portion in an enlarged scale.

FIG. 6 is an explanatory view illustrating, in schematic form, an FPC terminal portion, as a comparative example, on which solders are pre-coated.

FIG. 7 is a perspective view illustrating, in schematic form, the FPC terminal portion, as the comparative example, on which the solders are pre-coated.

FIG. 8A is an explanatory view illustrating, in schematic form, a state where the suspension terminal portion is arranged opposite to the comparative FPC terminal portion on which the solders are pre-coated, and FIG. 8B is an explanatory view illustrating a state where the comparative FPC terminal portion and the suspension terminal portion are joined to each other by solder bonding.

FIG. 9 is an explanatory view illustrating, in schematic form, an FPC terminal portion, according to the first embodiment, on which solders are pre-coated.

FIG. 10 is an explanatory view illustrating a state where the FPC terminal portion according to the first embodiment and the suspension terminal portion are joined to each other by solder bonding.

FIG. 11 illustrates steps of a solder bonding method according to the first embodiment.

FIG. 12 is an explanatory view illustrating a state where the FPC terminal portion according to another embodiment and the suspension terminal portion are joined to each other by solder bonding.

FIG. 13 is a perspective view illustrating, in schematic form, an FPC terminal portion, according to a second embodiment, on which solders are pre-coated.

FIG. 14 is a perspective view illustrating, in schematic form, an FPC terminal portion, according to a third embodiment, on which solders are pre-coated.

FIG. 15 is an explanatory view illustrating a state where the FPC terminal portion according to the third embodiment and the suspension terminal portion are joined to each other by solder bonding.

FIG. 16 illustrates steps of a solder bonding method according to the third embodiment.

FIG. 17A is a perspective view illustrating, in schematic form, a suspension terminal portion according to another embodiment, FIG. 17B is a perspective view illustrating, in schematic form, the FPC terminal portion on which the solders are pre-coated, and FIG. 17C is a sectional view of the suspension terminal portion illustrated in FIG. 7A.

FIG. 18 is a perspective view illustrating, in schematic form, an FPC terminal portion, according to a fourth embodiment, on which solders are pre-coated.

FIG. 19 is an explanatory view illustrating a state where the FPC terminal portion according to the fourth embodiment and the suspension terminal portion are joined to each other by solder bonding.

FIG. 20 illustrates steps of a solder bonding method according to the fourth embodiment.

FIG. 21 is a perspective view illustrating, in schematic form, an FPC terminal portion according to a modification of the fourth embodiment.

FIGS. 22A and 22B are perspective views illustrating, in schematic form, respective parts of the suspension terminal portion and an FPC terminal portion, according to a fifth embodiment, on which solders are pre-coated.

FIG. 23 is an explanatory view illustrating a state where the FPC terminal portion according to the fifth embodiment and the suspension terminal portion are joined to each other by solder bonding.

FIG. 24 illustrates steps of a solder bonding method according to the fifth embodiment.

FIG. 25 is a perspective view illustrating, in schematic form, an FPC terminal portion, according to a sixth embodiment, on which solders are pre-coated.

FIG. 26 is an explanatory view illustrating a state where the FPC terminal portion according to the sixth embodiment and the suspension terminal portion are joined to each other by solder bonding.

FIG. 27 illustrates steps of a solder bonding method according to the sixth embodiment.

FIGS. 28A and 28B are perspective views illustrating, in schematic form, respective parts of a suspension terminal portion and an FPC terminal portion, on each of which solders are pre-coated, according to a seventh embodiment.

FIG. 29 is an explanatory view illustrating, in schematic form, a state where the suspension terminal portion on which the solders are pre-coated is arranged opposite to the FPC terminal portion on which the solders are pre-coated, according to the seventh embodiment.

FIG. 30 is an explanatory view illustrating a state where the FPC terminal portion and the suspension terminal portion, according to the seventh embodiment, are joined to each other by solder bonding.

FIG. 31 illustrates steps of a solder bonding method according to the seventh embodiment.

FIGS. 32A and 32B are perspective views illustrating, in schematic form, respective parts of the suspension terminal portion and an FPC terminal portion, according to an eighth embodiment, on which solders are pre-coated.

FIG. 33 is an explanatory view illustrating a state where the FPC terminal portion according to the eighth embodiment and the suspension terminal portion are joined to each other by solder bonding.

FIG. 34 is a perspective view illustrating, in schematic form, an FPC terminal portion according to a ninth embodiment.

FIG. 35 is a sectional view of the FPC terminal portion illustrated in FIG. 34. FIG. 36 illustrates steps of a solder bonding method according to the ninth embodiment.

FIG. 37 is a perspective view illustrating, in schematic form, an FPC terminal portion according to a tenth embodiment.

FIG. 38 is a sectional view of the FPC terminal portion illustrated in FIG. 37.

### DESCRIPTION OF EMBODIMENTS

Embodiments will be described below with reference to the attached drawings. Be it noted that dimensions of components in the drawings, dimension ratios among the components, etc. are not illustrated in complete match with the actual dimensions, dimension ratios, etc. in some cases. Also, details are omitted in some of the drawings.

### First Embodiment

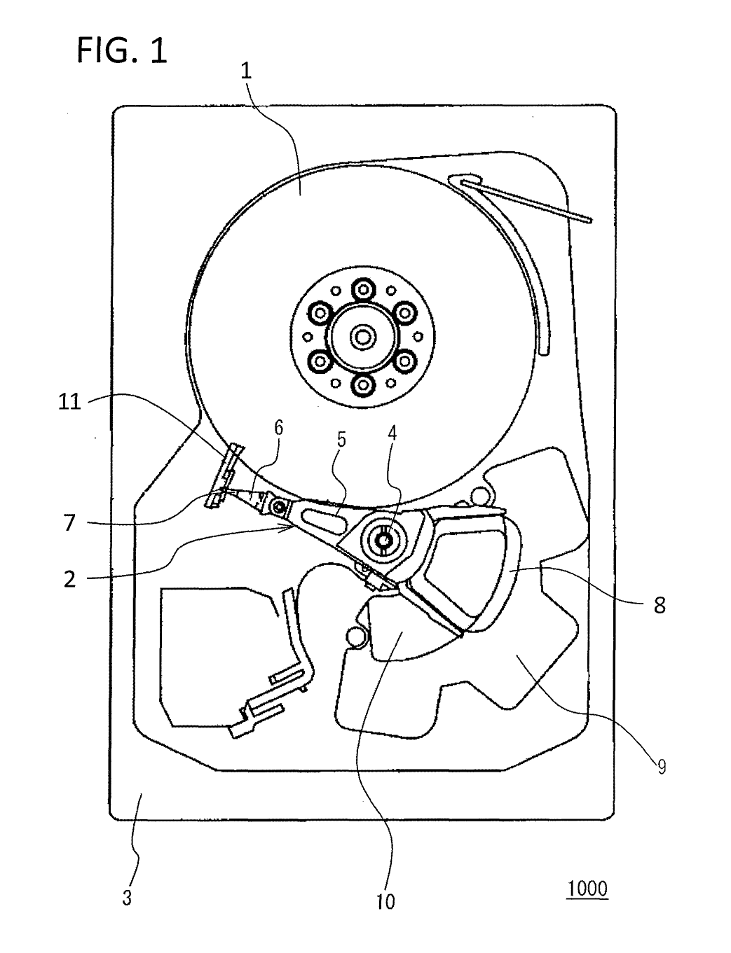

FIG. 1 is an explanatory view illustrating an internal structure of a magnetic disk device 1000, to which a solder joint structure according to a first embodiment is applied, on the side including a housing base with a housing cover removed. The magnetic disk device 1000 represents one example of an electronic device described in this specification. The electronic device may be some other suitable device than the magnetic disk device.

As illustrated in FIG. 1, the magnetic disk device 1000 includes, within a housing base 3, a magnetic disk 1 which is rotated at a constant speed by a spindle motor. A rotary actuator 2 is disposed near the magnetic disk 1.

The rotary actuator 2 is rotatably supported at its shaft portion 4 by the housing base 3. The rotary actuator 2 includes a head gimbal assembly 6 on the fore end side thereof with an arm 5 interposed between them, and a head 7 is supported by the head gimbal assembly 6. A coil 8 is mounted to the rear end side of the rotary actuator 2.

A magnetic circuit portion fixed to the housing base 3 is disposed near the coil 8 of the rotary actuator 2. The coil 8 and the magnetic circuit portion jointly constitute a voice coil motor for driving the rotary actuator 2.

A magnet 10 included in the magnetic circuit portion on the side near the housing base 3 is arranged on a lower yoke 9 which is fixed to the housing base 3. The magnet 10 has a shape covering a range over which the coil 8 is rotated with the rotary actuator 2.

The coil 8 positioned in a rear part of the rotary actuator 2 is arranged on the magnet 10 to be rotatable about the shaft portion 4. An upper yoke having the same shape as the lower yoke 9 is arranged on the coil 8 in opposite relation to the lower yoke 9. Be it noted that FIG. 1 illustrates a state where the upper yoke is removed (omitted).

An FPC (Flexible Print Circuit) 12 is led out from a lateral surface of the rotary actuator 2 to a circuit mounted portion on the fixed side. On the FPC 12, signal lines connected to the head 7 and signal lines connected to the coil 8 are formed as flexible print patterns. Also, the FPC 12 mounts thereon a head IC including a write driver which executes signal processing for a recording element and a reading element in the head 7, and a preamplifier. The FPC 12 transfers a control signal, a write signal, a read signal, etc. with respect to a control board which is arranged on the housing base 3. In FIG. 1, reference numeral 11 denotes a ramp loading mechanism.

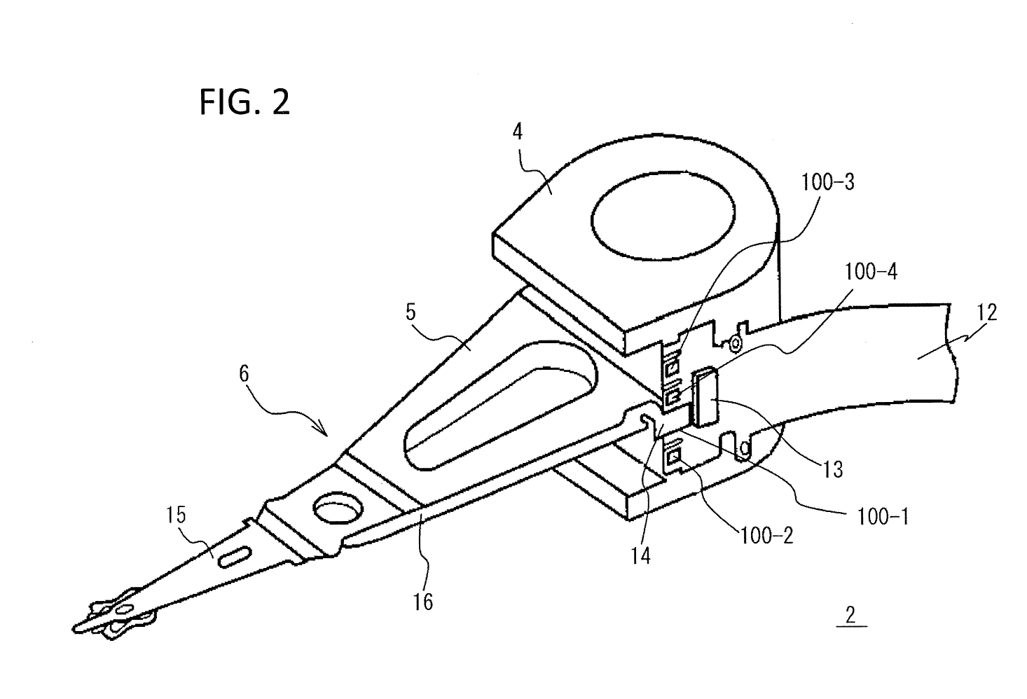

FIG. 2 is an explanatory view illustrating the rotary actuator 2 in the magnetic disk device 1000, the rotary actuator 2 being taken out from the magnetic disk device 1000 and illustrated in a partly omitted state. In FIG. 2, the rotary actuator 2 includes the head gimbal assembly 6 which is fixed to the arm 5 by crimping, the arm 5 being extended from the shaft portion 4. The head gimbal assembly 6 includes a suspension attachment arm 15 and a long tail suspension 16.

A fore end of the long tail suspension 16 is disposed under the suspension attachment arm 15, and the head 7 including the recording element, the reading element, and a slider is supported to a fore end of the suspension attachment arm 15. A rear end of the long tail suspension 16 is mounted to a lateral surface of the arm 5. Further, the long tail suspension 16 includes at its rear end a suspension terminal portion 14 for electrical connection to the FPC 12 which is fixedly supported to a lateral surface of the shaft portion 4 of the rotary actuator 2.

One end of the FPC 12 is fixed to the lateral surface of the shaft portion 4 of the rotary actuator 2, and a head IC 13 is mounted to the one end of the FPC 12. FPC terminal portions 100-1 to 100-4 are formed at the one end of the FPC 12 for electrical connection to the suspension terminal portion 14 of the long tail suspension 16 which is included in the head gimbal assembly 6.

Herein, each of the FPC terminal portions 100-1 to 100-4 provided on the FPC 12 represents one example of a first terminal portion in this specification. Also, the suspension terminal portion 14 represents one example of a second terminal portion in this specification. As a matter of course, each of the FPC terminal portions 100-1 to 100-4 may represent one example of the first terminal portion in this specification, and the suspension terminal portion 14 may represent one example of the second terminal portion in this specification.

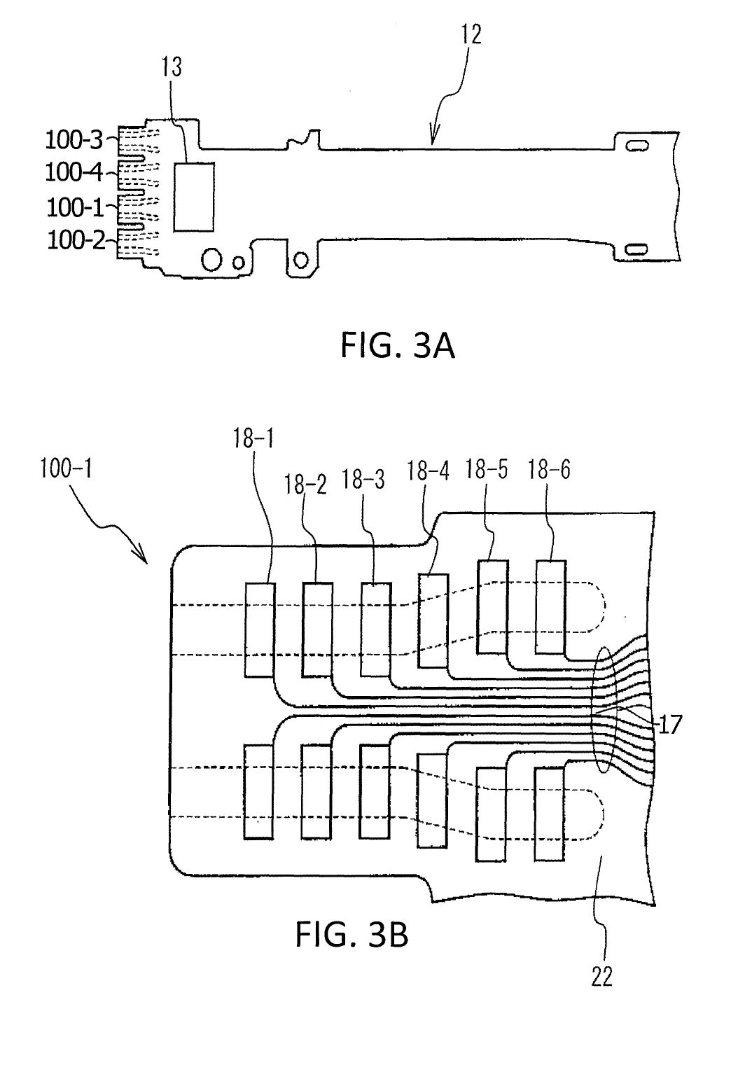

FIGS. 3A and 3B are respectively an explanatory view illustrating the FPC 12 in the rotary actuator 2, the FPC 12 being taken out from the rotary actuator 2, and an enlarged view of one 100-1 of the FPC terminal portions 100-1 to 100-4. FIG. 3A illustrates part of the FPC 12 on the side near the rotary actuator. The FPC terminal portions 100-1 to 100-4 are formed at the fore end of the FPC 12. The head IC 13 is mounted behind the FPC terminal portions 100-1 to 100-4. As illustrated in FIGS. 3B, 9 and 10, the FPC 12 includes wiring patterns 17 which are formed on a flexible base film 21 so as to constitute a circuit and FPC terminal conductors 18-1 to 18-6. A cover film 22 is laminated on an area where the wiring pattern 17 is not connected.

FIG. 3B illustrates, in an enlarged scale, the FPC terminal portion 100-1 in FIG. 3A. The FPC terminal portion 100-1 includes a plurality of FPC terminal conductors 18-1 to 18-6 which are arranged adjacent to each other. Herein, the FPC terminal conductors 18-1 to 18-6 represent one example of first terminal conductors in this specification. In some of other drawings, only part of the FPC terminal conductors 18-1 to 18-6, i.e., only the FPC terminal conductors 18-1 to 18-3, are illustrated.

As denoted by dotted lines in FIG. 3B, the cover film 22 is opened at positions corresponding to the FPC terminal conductors 18-1 to 18-6 such that respective conductive surfaces of the FPC terminal conductors 18-1 to 18-6 are exposed to the exterior in the openings of the cover film 22. Further, the wiring patterns 17 are led out from the FPC terminal conductors 18-1 to 18-6 and are extended as a wiring pattern group toward the housing base side.

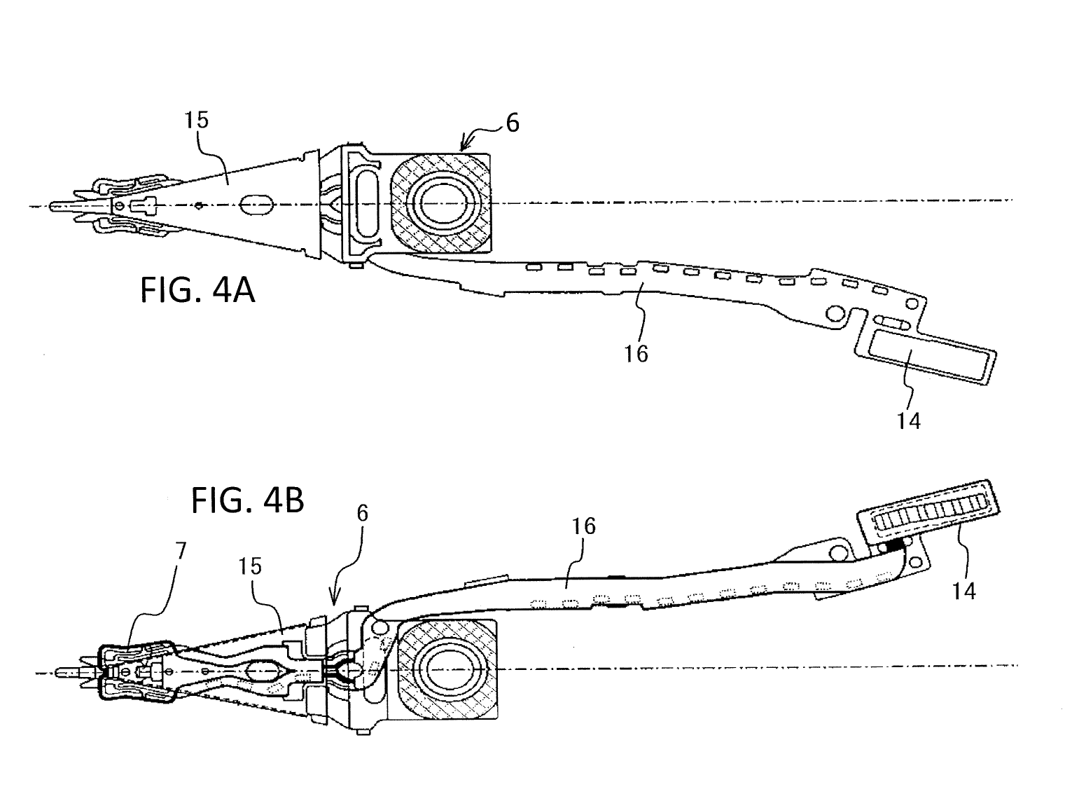

FIGS. 4A and 4B illustrate the head gimbal assembly 6 in the rotary actuator 2, the head gimbal assembly 6 being taken out from the rotary actuator 2. More specifically, FIG. 4A is a plan view of the head gimbal assembly 6, and FIG. 4B is a rear view illustrating the rear side of the head gimbal assembly 6.

The head gimbal assembly 6 includes the long tail suspension 16 which is fixed to the rear side of the suspension attachment arm 15 by bonding. The long tail suspension 16 includes the head 7 at its fore end and the suspension terminal portion 14 on the tail side thereof. The head 7 and the suspension terminal portion 14 are connected to each other through circuit patterns. In other words, the long tail suspension 16 has a function of electrically connecting the head 7 and the head IC 13 of the FPC 12, illustrated in FIG. 2, to each other. A transmission path on the long tail suspension 16 is formed as a thin-film circuit by a semiconductor manufacturing process through the steps of coating an insulating layer on a metal foil, e.g., a stainless foil, forming a circuit layer by Cu plating, for example, further forming a protective layer on the circuit layer, and edging a stainless layer.

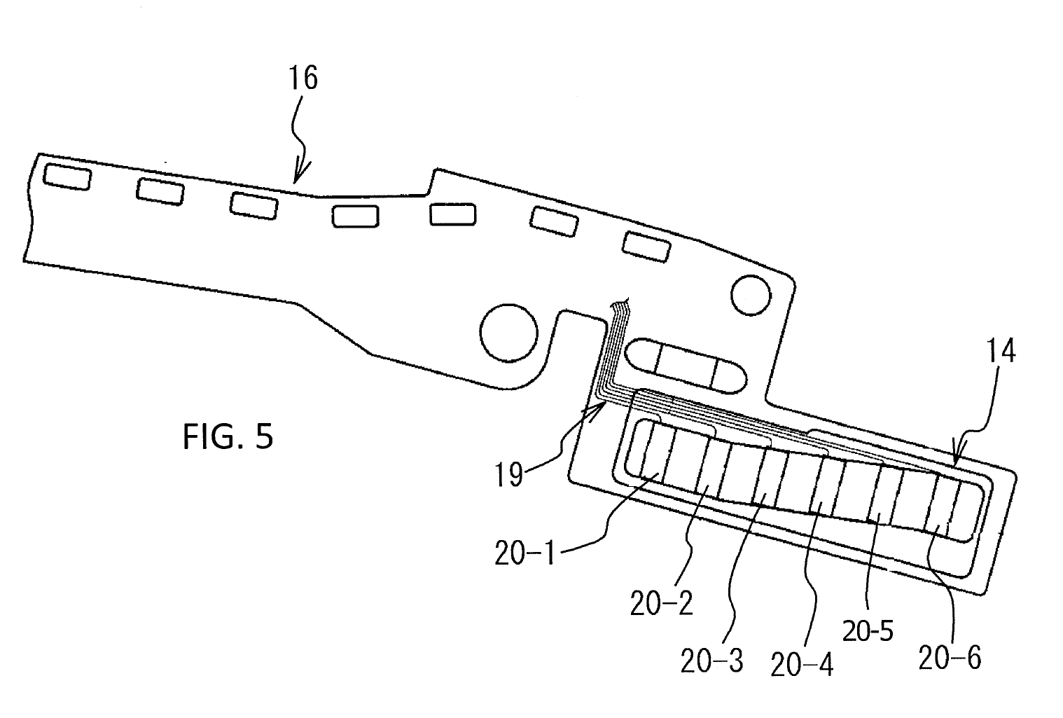

FIG. 5 is an explanatory view illustrating the suspension terminal portion 14 in an enlarged scale. In FIG. 5, the suspension terminal portion 14, which represents one example of the second terminal portion in this specification, is disposed at an end of the long tail suspension 16 on the tail side thereof.

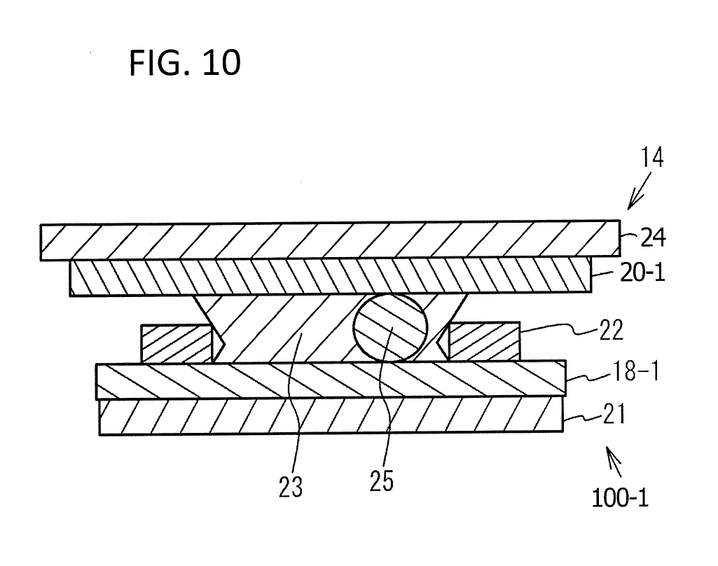

The suspension terminal portion 14 includes suspension terminal conductors 20-1 to 20-6 which are arrayed on a base film 24 (see FIG. 10) at constant intervals. Wiring patterns 19 are led out from the suspension terminal conductors 20-1 to 20-6 and are connected to the head 7 illustrated in FIG. 4. The wiring patterns 19 are covered with a protective layer except for areas where the suspension terminal conductors 20-1 to 20-6 are exposed.

In the long tail suspension 16 according to the first embodiment, the head 7 illustrated in FIG. 4 includes not only the recording element and the reading element, but also a heater element for controlling an amount of head levitation by utilizing thermal expansion. Because two wiring patterns are requested for each of the recording element, the reading element, and the heater element, a total of six suspension terminal conductors 20-1 to 20-6 are disposed on the suspension terminal portion 14.

Herein, the suspension terminal conductors 20-1 to 20-6 represent one example of second terminal conductors in this specification.

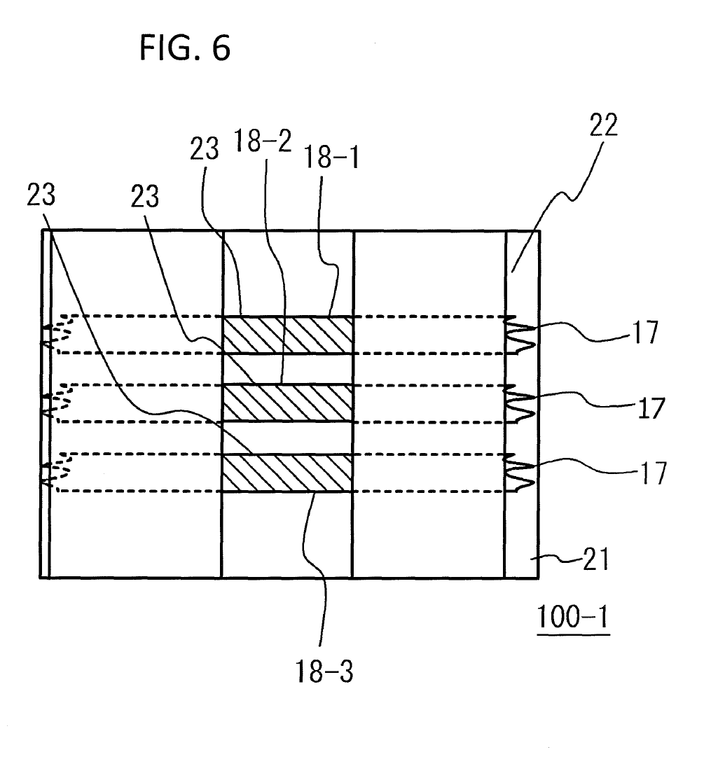

Solder bonding for electrically joining the FPC terminal portion 100-1 and the suspension terminal portion 14 in the head gimbal assembly 6 to each other will be described below. Prior to describing the solder bonding according to the first embodiment, a comparative example of solder bonding is described with reference to FIGS. 6 to 8. In the comparative example, components common to those in the first embodiment are denoted by the same reference numerals in FIGS. 6 to 8.

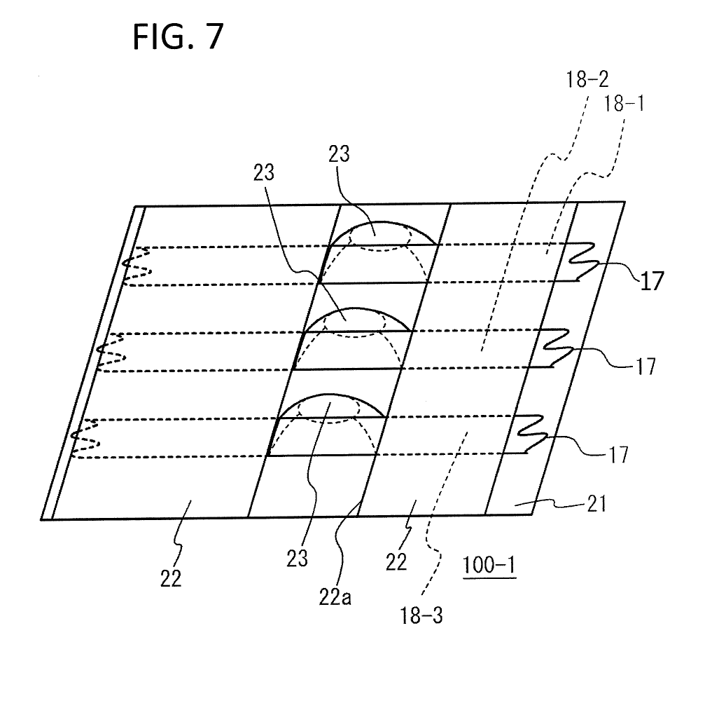

FIG. 6 is an explanatory view illustrating, in schematic form, a state where solders 23 are disposed on the FPC terminal conductors 18-1 to 18-3 in advance before the bonding in the comparative example, i.e., a state of the FPC terminal portion 100-1 on which solders are pre-coated. FIG. 7 is a perspective view illustrating, in schematic form, the FPC terminal portion 100-1 as the comparative example. As described above, the FPC terminal portion 100-1 is disposed on the flexible base film 21 and the cover film 22 is laminated on the base film 21. An opening 22a is formed in the cover film 22, and the solders 23 are pre-coated on the FPC terminal conductors 18-1 to 18-3 which are exposed through the opening 22a.

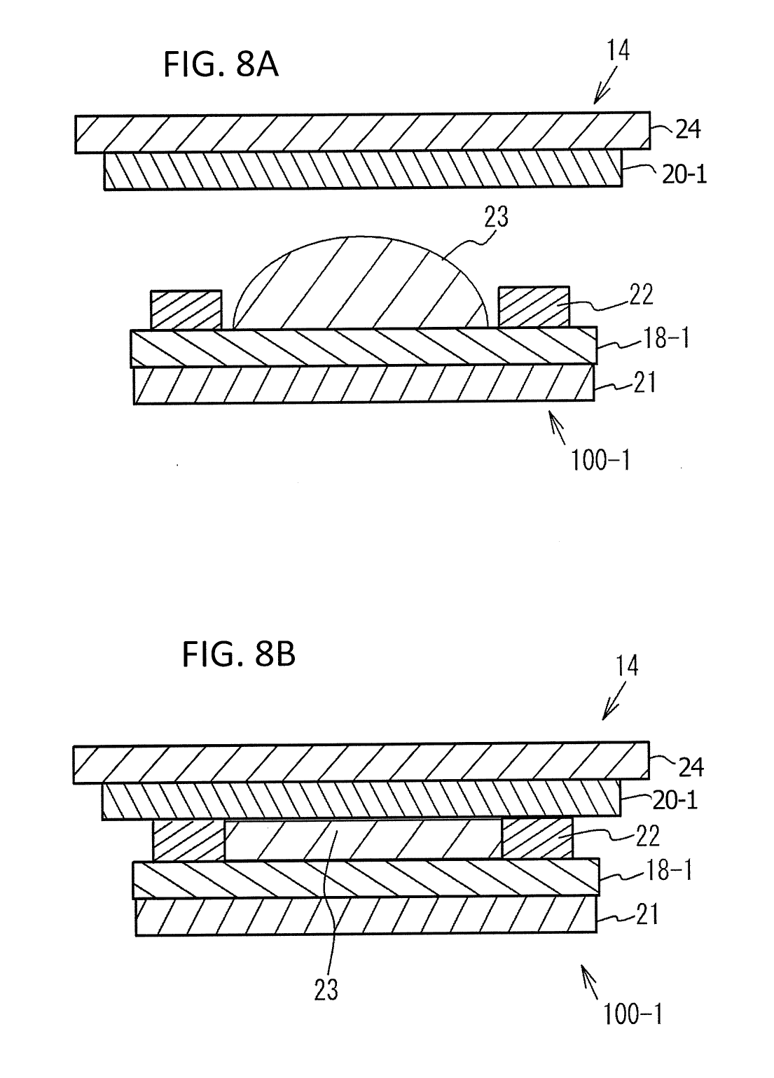

FIG. 8A is an explanatory view illustrating, in schematic form, a state where the suspension terminal portion 14 is arranged opposite to the comparative FPC terminal portion 100-1 on which the solders are pre-coated. FIG. 8B is an explanatory view illustrating a state where the comparative FPC terminal portion 100-1 and the suspension terminal portion 14 are joined to each other by solder bonding. The solder bonding between the FPC terminal portion 100-1 and the suspension terminal portion 14 is performed by melting the solders 23 with heat and applying pressure such that the FPC terminal portion 100-1 and the suspension terminal portion 14 arranged in opposite relation are pressed against each other. Therefore, the molten solders 23 are caused to flow toward the surroundings. Such flow of the solders 23 is more apt to occur and regions over which the solders 23 are caused to flow are also increased as a gap between the FPC terminal portion 100-1 and the suspension terminal portion 14 is narrowed. With larger flow regions of the solders 23, short-circuiting becomes more apt to occur between adjacent two of the FPC terminal conductors 18-1 to 18-6.

Thus, the comparative example accompanies with a risk that short-circuiting may occur due to the flow of the solders 23 when pressure is applied to between the FPC terminal portion 100-1 and the suspension terminal portion 14 which are arranged opposite to each other.

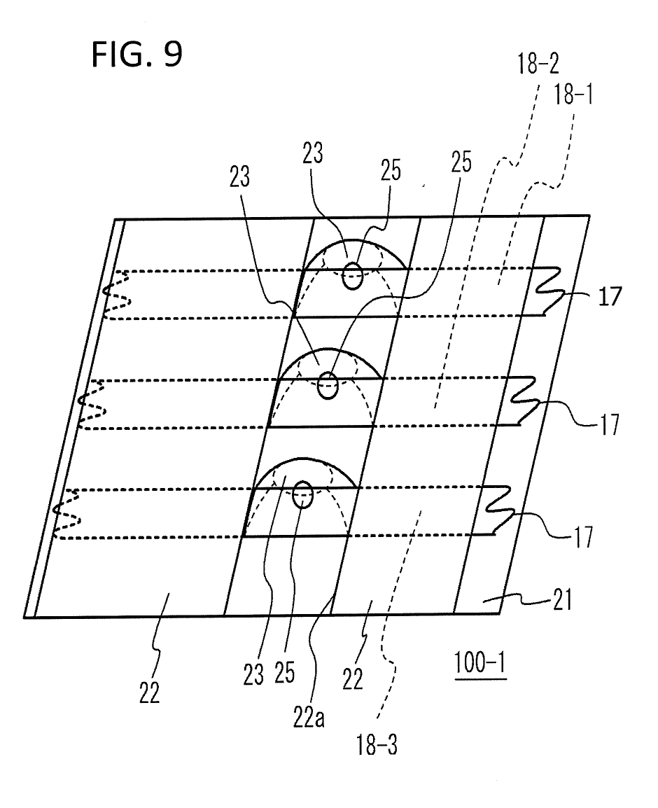

Next, solder bonding according to the first embodiment will be described below with reference to FIGS. 9 to 11. FIG. 9 is an explanatory view illustrating, in schematic form, the FPC terminal portion 100-1 on which solders are pre-coated. FIG. 10 is an explanatory view illustrating a state where the FPC terminal portion 100-1 and the suspension terminal portion 14 are joined to each other by solder bonding.

In the solder bonding according to the first embodiment, unlike the comparative example, a metal ball 25 representing one example of means for suppressing flow of the solders (i.e., solder flow suppressing means) is included in each solder 23. During the solder bonding, as illustrated in FIG. 10, the metal ball 25 is positioned between the FPC terminal portion 100-1 and the suspension terminal portion 14. Therefore, when pressure is applied to between the FPC terminal portion 100-1 and the suspension terminal portion 14, they are avoided from coming too close to each other and an appropriate standoff amount is held between them. With the appropriate standoff amount held, the molten solders 23 are avoided from flowing excessively. As a result, the short-circuiting between adjacent two of the FPC terminal conductors 18-1 to 18-6 may be prevented. In other words, the metal ball 25 may be said as a member for adjusting the gap between the FPC terminal portion 100-1 and the suspension terminal portion 14.

Cu, Ni, Fe, etc. may be used as materials of the metal ball 25. Desirably, the metal ball 25 is not molten even when it is positioned in the molten solder 23, and it has such rigidity as not breaking when pressure is applied to between the FPC terminal portion 100-1 and the suspension terminal portion 14. The materials are not limited to metals and a ball made of some other suitable material may also be used as the solder flow suppressing means, i.e., the gap adjusting member, so long as the material has the above-mentioned desired properties. A solder material differing in compositions from the solder 23 and having a higher melting point than the solder 23 may also be used. For example, it is possible to use an Sn—Bi—Ag-based solder material having a melting point of about 140° C. for the solder 23, and to use an Sn—Pb-based solder material having a melting point of about 180° C. for the other solder. Further an Sn—Ag—Cu-based solder material having a melting point of about 218° C. may also be used for the other solder. By using the solder materials having different melting points, only the solder 23 may be made molten while the other solder functions as the gap adjusting member.

The size of the metal ball 25 is desirably set such that its diameter is greater than the thickness of the cover film 22, but the ball is buried in the solder 23 during the bonding. With the metal ball 25 buried in the solder 23, a bonding area of the solder 23 may be ensured.

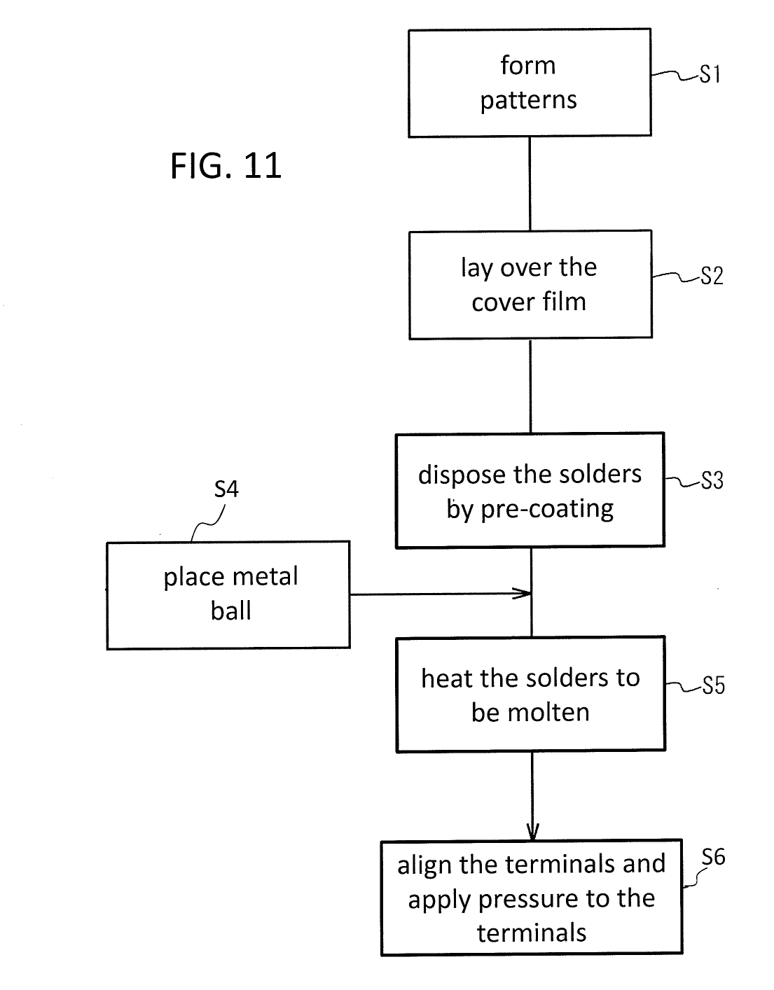

A solder bonding method according to the first embodiment will be described below with reference to a step chart illustrated in FIG. 11.

First, in step S1, patterns are formed. The patterns are formed on both the FPC terminal portion 100-1 and the suspension terminal portion 14. More specifically, patterns including the FPC terminal conductors 18-1 to 18-6 and the wiring patterns 17 are printed on the base film 21 of the FPC terminal portion 100-1. On the other hand, patterns including the suspension terminal conductors 20-1 to 20-6 are printed on the base film 24 of the suspension terminal portion 14.

In such a manner, the FPC terminal conductors 18-1 to 18-6 and the suspension terminal conductors 20-1 to 20-6 are formed.

In step S2, the cover film 22 is laid over and stuck to (i.e., laminated on) the base film 21 of the FPC terminal portion 100-1. Though not illustrated in the first embodiment, a cover film may also be stuck to the base film 24 on the suspension terminal portion 14.

In step S3, the solders 23 are disposed on parts of the FPC terminal conductors 18-1 to 18-6, which are exposed through the cover film 22. The solders 23 are disposed by pre-coating.

In step S4, the metal balls 25 are placed respectively on the solders 23. Then, in step S5, the solders 23 are heated to be molten. With the melting of the solders 23, the metal balls 25 are buried in the solders 23. Thus, the solder flow suppressing means are formed. A possibility of the metal balls 25 dislodging from the solders 23 is low because the metal balls 25 are buried in the solders 23.

After the end of step S5, the process advances to step S6. In step S6, the FPC terminal portion 100-1 and the suspension terminal portion 14 are positioned in opposite relation such that the FPC terminal conductors 18-1 to 18-6 and the suspension terminal conductors 20-1 to 20-6 are aligned with each other. Further, pressure is applied to between the FPC terminal portion 100-1 and the suspension terminal portion 14. As a result, they are joined to each other by pressure solder bonding.

At that time, since the metal balls 25 are present between the FPC terminal portion 100-1 and the suspension terminal portion 14, the appropriate standoff amount is held between the FPC terminal portion 100-1 and the suspension terminal portion 14. Accordingly, the flow of the solders 23 is suppressed and the short-circuiting is prevented.

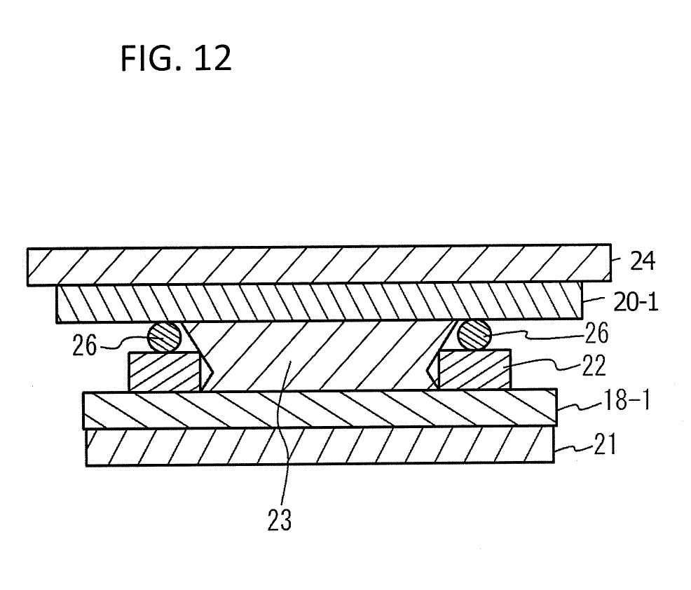

Instead of the metal balls 25, as illustrated in FIG. 12, other metal balls 26 may be used which are disposed on the cover film 22. Those metal balls 26 may also function as the gap adjusting members to hold the appropriate standoff amount between the FPC terminal portion 100-1 and the suspension terminal portion 14. The metal balls 26 may be made of other suitable materials than metals similarly to the metal balls 25.

### Second Embodiment

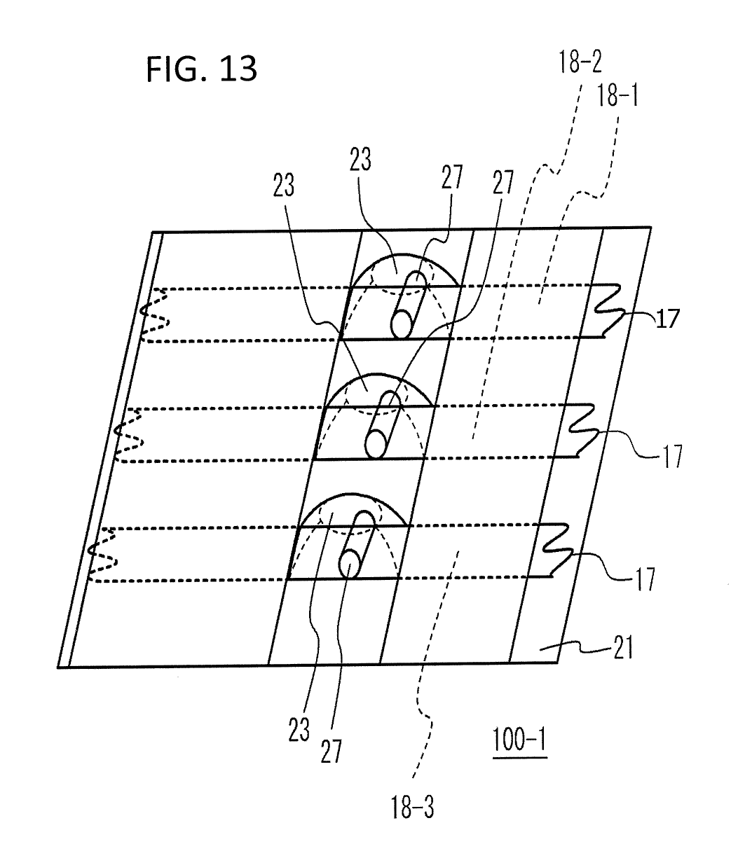

A second embodiment will be described below with reference to FIG. 13. FIG. 13 is a perspective view illustrating, in schematic form, an FPC terminal portion 100-1, according to the second embodiment, on which solders are pre-coated. Be it noted that components in the second embodiment, which are common to those in the first embodiment, are denoted by the same reference numerals in FIG. 13 and detailed descriptions of those components are omitted.

The second embodiment differs from the first embodiment in the following point. In the second embodiment, a metal wire 27 is used instead of the metal ball 25 in the first embodiment. The properties requested for the metal wire 27 are substantially the same as those requested for the metal ball 25. For example, a copper wire may be used as the metal wire 27. The metal wire 27 is easier to prepare because it may be employed just by cutting a long wire to an appropriate length. The metal wire 27 also represents one example of the gap adjusting member.

With the second embodiment described above, as with the first embodiment, the appropriate standoff amount is held between the FPC terminal portion 100-1 and the suspension terminal portion 14. Accordingly, the flow of the solders 23 may be suppressed and the short-circuiting may be prevented.

### Third Embodiment

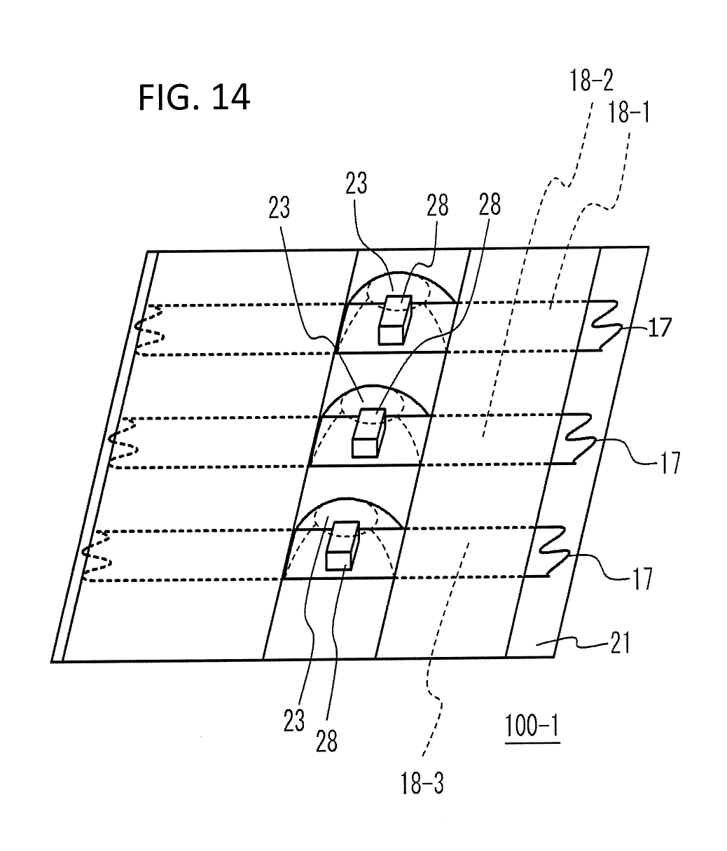

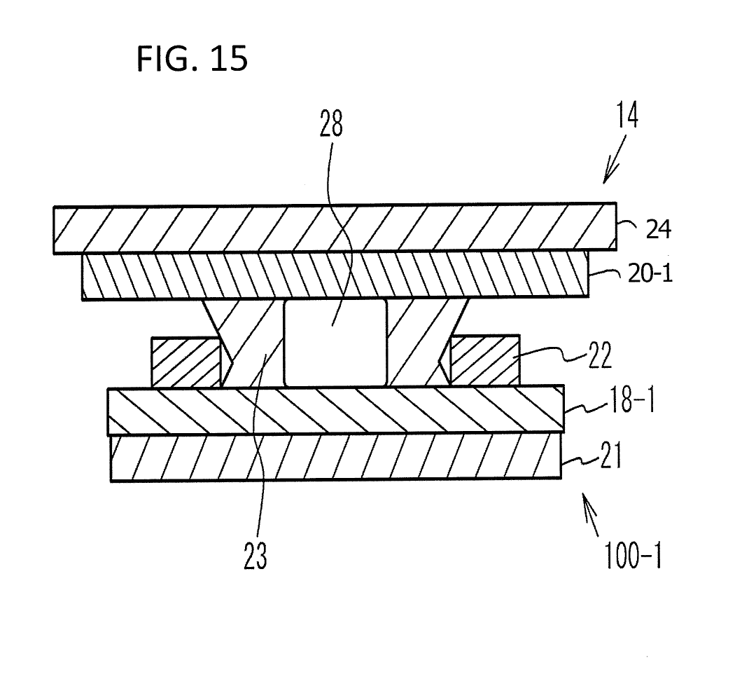

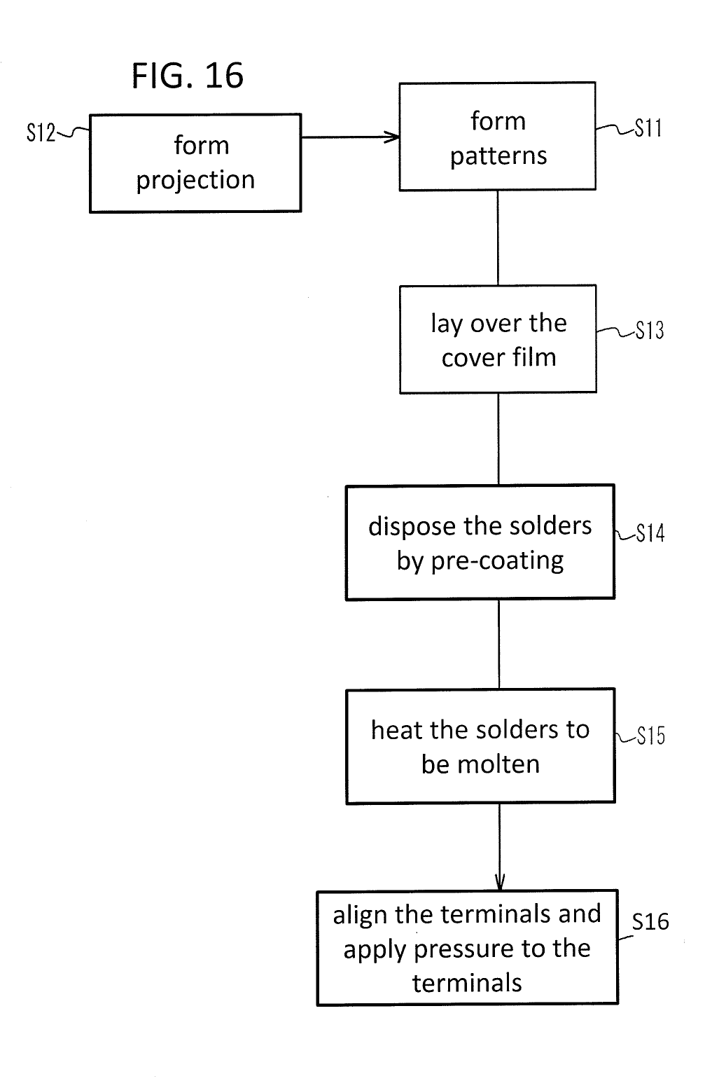

A third embodiment will be described below with reference to FIGS. 14 to 16. FIG. 14 is a perspective view illustrating, in schematic form, an FPC terminal portion 100-1, according to the third embodiment, on which solders are pre-coated. FIG. 15 is an explanatory view illustrating a state where the FPC terminal portion 100-1 and the suspension terminal portion 14 are joined to each other by solder bonding. FIG. 16 illustrates steps of a solder bonding method according to the third embodiment. Be it noted that components in the third embodiment, which are common to those in the first embodiment, are denoted by the same reference numerals in the drawings and detailed descriptions of those components are omitted.

The third embodiment differs from the first embodiment in the following point. In the third embodiment, a projection 28 formed by plating is used instead of the metal ball 25 in the first embodiment. The projection 28 is provided on the surface of each of the FPC terminal conductors 18-1 to 18-6. The projection 28 is formed by using the same material as that of the FPC terminal conductors 18-1 to 18-6. Stated another way, when the FPC terminal conductors 18-1 to 18-6 are made of Cu, the projection 28 is also formed by using Cu. Using the same material eliminates additional time and labor necessary to prepare another material for the projection 28. However, the projection 28 may be formed by using another material. In such a case, Ni, for example, may be used as the other material. The properties requested for the projection 28 are substantially the same as those requested for the metal ball 25. The projection 28 also represents one example of the gap adjusting member.

With the third embodiment described above, as with the first embodiment, the appropriate standoff amount is held between the FPC terminal portion 100-1 and the suspension terminal portion 14 as illustrated in FIG. 15. Accordingly, the flow of the solders 23 may be suppressed and the short-circuiting may be prevented.

The solder bonding method according to the third embodiment will be described below with reference to a step chart illustrated in FIG. 16.

First, in step S11, patterns are formed. The patterns are formed on both the FPC terminal portion 100-1 and the suspension terminal portion 14. More specifically, patterns including the FPC terminal conductors 18-1 to 18-6 and the wiring patterns 17 are printed on the base film 21 of the FPC terminal portion 100-1. On the other hand, patterns including the suspension terminal conductors 20-1 to 20-6 are printed on the base film 24 of the suspension terminal portion 14.

In such a manner, the FPC terminal conductors 18-1 to 18-6 and the suspension terminal conductors 20-1 to 20-6 are formed.

A process of step S12 is carried out in parallel to step S11. More specifically, the projections 28 are formed by plating. When the wiring patterns 17 and the projections 28 are made of the same material, they may be formed in a single step. When the wiring patterns 17 and the projections 28 are made of different materials, the projections 28 are formed after forming the wiring patterns 17. The step of forming the projections 28 represents one example of a step of providing means for suppressing flow of the solders in this specification.

In step S13 subsequent to steps S11 and S12, the cover film 22 is laid over and stuck to (i.e., laminated on) the base film 21 of the FPC terminal portion 100-1.

In step S14, the solders 23 are disposed on parts of the FPC terminal conductors 18-1 to 18-6, which are exposed through the cover film 22. The solders 23 are disposed by pre-coating. At that time, the pre-coating is performed such that the solders 23 cover the projections 28, respectively.

In step S15, the solders 23 are heated to be molten. With the melting of the solders 23, the metal balls 25 are buried in the solders 23. Then, in step 516, the FPC terminal portion 100-1 and the suspension terminal portion 14 are positioned in opposite relation such that the FPC terminal conductors 18-1 to 18-6 and the suspension terminal conductors 20-1 to 20-6 are aligned with each other. Further, pressure is applied to between the FPC terminal portion 100-1 and the suspension terminal portion 14. As a result, they are joined to each other by pressure solder bonding.

At that time, since the projections 28 are present between the FPC terminal portion 100-1 and the suspension terminal portion 14, the appropriate standoff amount is held between the FPC terminal portion 100-1 and the suspension terminal portion 14. Accordingly, the flow of the solders 23 is suppressed and the short-circuiting is prevented.

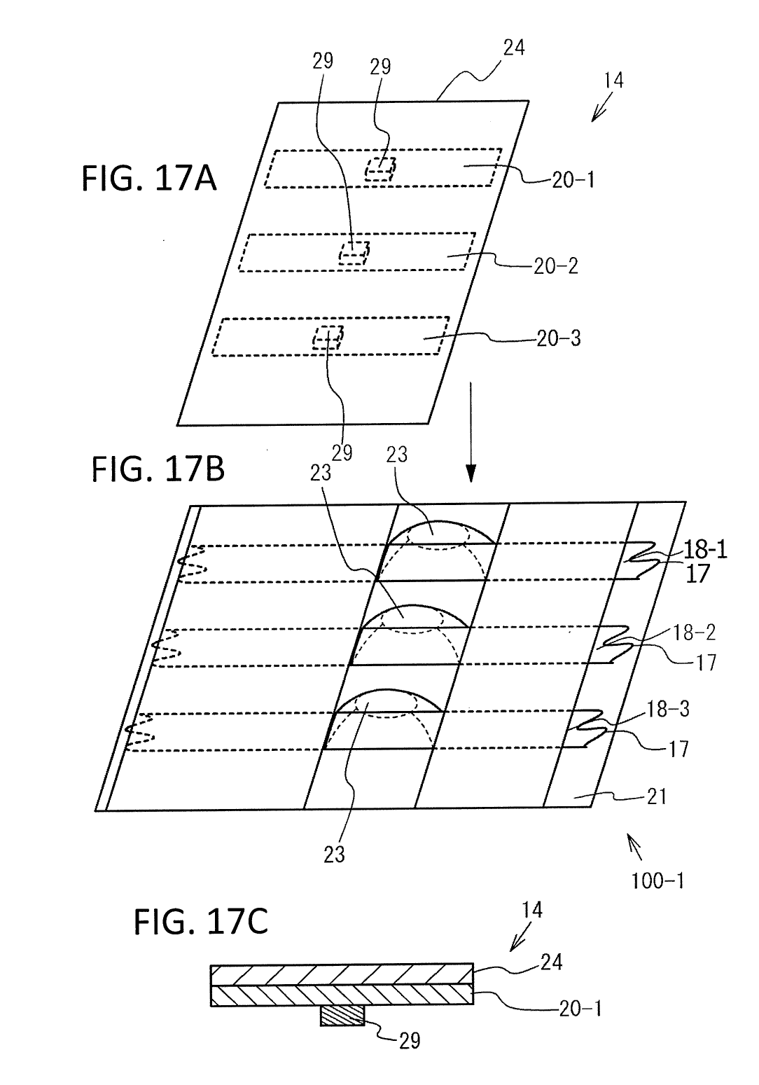

Instead of the projections 28, as illustrated in FIGS. 17A, 17B and 17C, other projections 29 may be used which are provided on the suspension terminal portion 14. FIG. 17A is a perspective view illustrating, in schematic form, a suspension terminal portion 14 according to such a modification, FIG. 17B is a perspective view illustrating, in schematic form, the FPC terminal portion 100-1 on which the solders are pre-coated, and FIG. 17C is a sectional view of the suspension terminal portion 14 illustrated in FIG. 17A. Even in the modification that the projections 29 are provided on the suspension terminal portion 14, the appropriate standoff amount may be held between the FPC terminal portion 100-1 and the suspension terminal portion 14. Accordingly, the flow of the solders 23 is suppressed and the short-circuiting is prevented.

The projections 29 may be formed by plating as with the projections 28.

### Fourth Embodiment

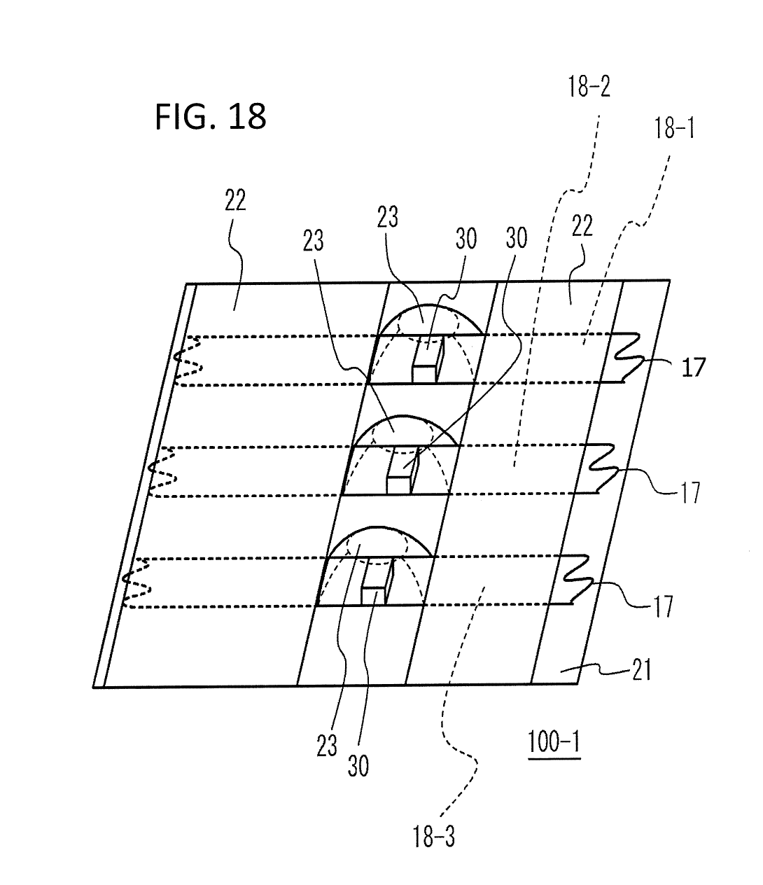

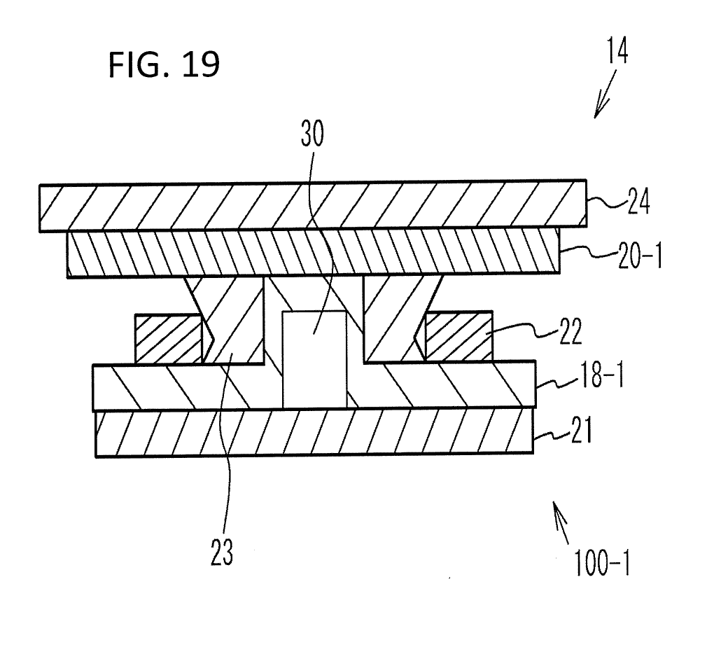

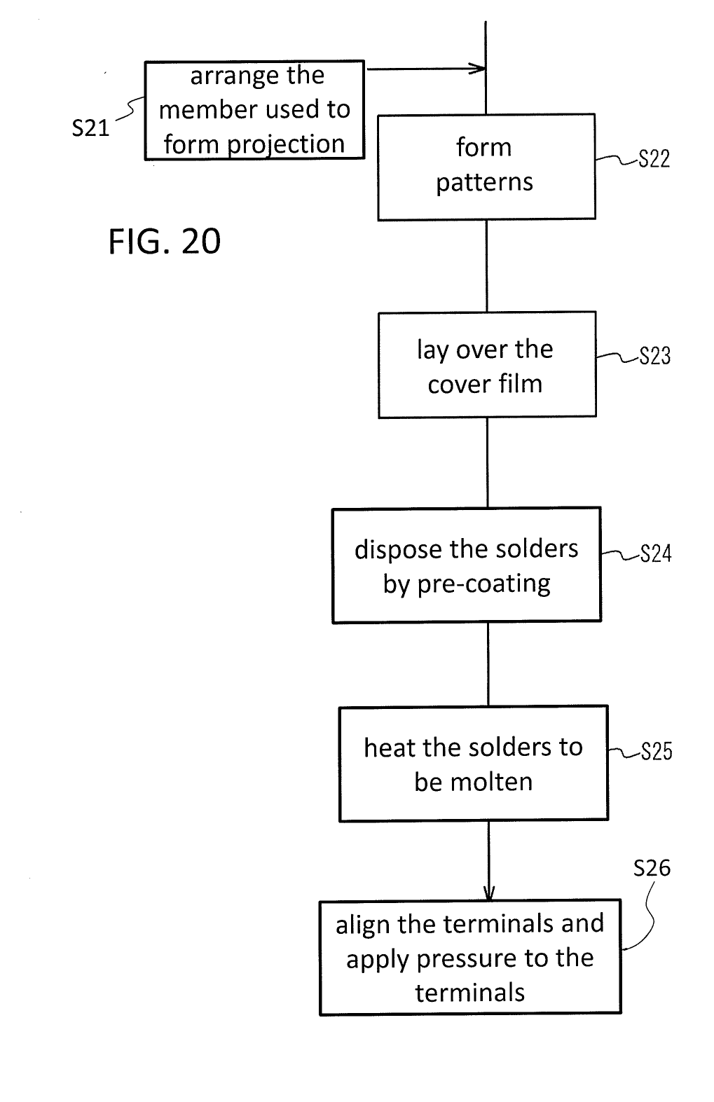

A fourth embodiment will be described below with reference to FIGS. 18 to 21. FIG. 18 is a perspective view illustrating, in schematic form, an FPC terminal portion 100-1, according to the fourth embodiment, on which solders are pre-coated. FIG. 19 is an explanatory view illustrating a state where the FPC terminal portion 100-1 and the suspension terminal portion 14 are joined to each other by solder bonding. FIG. 20 illustrates steps of a solder bonding method according to the fourth embodiment. Be it noted that components in the fourth embodiment, which are common to those in the first embodiment, are denoted by the same reference numerals in the drawings and detailed descriptions of those components are omitted.

The fourth embodiment differs from the first embodiment in the following point. In the fourth embodiment, a projection 30 formed by partly raising each of the FPC terminal conductors 18-1 to 18-6 is used instead of the metal ball 25 in the first embodiment. The projection 30 is formed by arranging a metal piece on the base film 21. Stated another way, the metal pieces are arranged on the base film 21, and the FPC terminal conductors 18-1 to 18-6 are formed over the metal pieces. The projection 30 is formed for each of the FPC terminal conductors 18-1 to 18-6. A member used to form the projection 30 is not limited to the metal piece, and it may be made of other suitable materials than metals.

With the fourth embodiment described above, as with the first embodiment, the appropriate standoff amount is held between the FPC terminal portion 100-1 and the suspension terminal portion 14 as illustrated in FIG. 19. Accordingly, the flow of the solders 23 may be suppressed and the short-circuiting may be prevented.

The solder bonding method according to the fourth embodiment will be described below with reference to a step chart illustrated in FIG. 20.

First, in step S21, metal pieces, i.e., members used to form the projections 30, are arranged on the base film 21. Then, in step S22, patterns are formed. The patterns are formed on both the FPC terminal portion 100-1 and the suspension terminal portion 14. More specifically, patterns including the FPC terminal conductors 18-1 to 18-6 and the wiring patterns 17 are printed on the base film 21 of the FPC terminal portion 100-1. At that time, the FPC terminal conductors 18-1 to 18-6 are disposed so as to lie over the metal pieces. As a result, the FPC terminal conductors 18-1 to 18-6 are each partly raised and the projections 30 are formed. On the other hand, patterns including the suspension terminal conductors 20-1 to 20-6 are printed on the base film 24 of the suspension terminal portion 14. The above-described step of arranging the metal pieces and forming the FPC terminal conductors 18-1 to 18-6 in the partly raised state represents one example of the step of providing means for suppressing flow of the solders in this specification.

In such a manner, the FPC terminal conductors 18-1 to 18-6 and the suspension terminal conductors 20-1 to 20-6 are formed.

In step S23 subsequent to step S22, the cover film 22 is laid over and stuck to (i.e., laminated on) the base film 21 of the FPC terminal portion 100-1.

In step S24, the solders 23 are disposed on parts of the FPC terminal conductors 18-1 to 18-6, which are exposed through the cover film 22. The solders 23 are disposed by pre-coating. At that time, the pre-coating is performed such that the solders 23 cover the projections 30, respectively.

In step S25, the solders 23 are heated to be molten. Then, in step S26, the FPC terminal portion 100-1 and the suspension terminal portion 14 are positioned in opposite relation such that the FPC terminal conductors 18-1 to 18-6 and the suspension terminal conductors 20-1 to 20-6 are aligned with each other. Further, pressure is applied to between the FPC terminal portion 100-1 and the suspension terminal portion 14. As a result, they are joined to each other by pressure solder bonding.

At that time, since the projections 30 are present between the FPC terminal portion 100-1 and the suspension terminal portion 14, the appropriate standoff amount is held between the FPC terminal portion 100-1 and the suspension terminal portion 14. Accordingly, the flow of the solders 23 is suppressed and the short-circuiting is prevented.

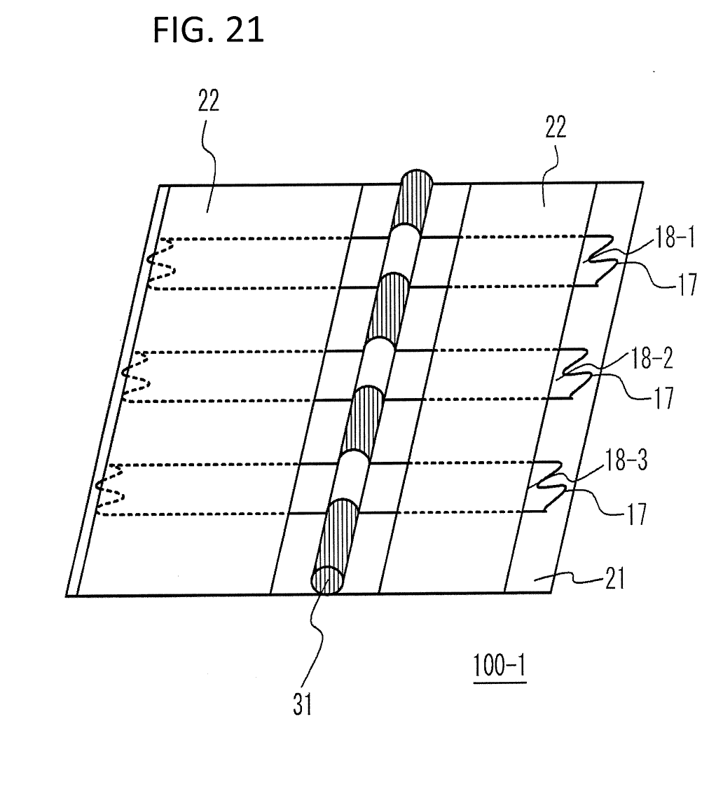

Instead of the projections 30, as illustrated in FIG. 21, other projections 31 may be provided which are formed by arranging a linear member. The linear member used to form the projections 31 is disposed in a length covering the FPC terminal conductors 18-1 to 18-6 adjacent to each other. The FPC terminal conductors 18-1 to 18-6 are formed on the linear member such that they are partly raised to form the projections 31. With a modification illustrated in FIG. 21, the projections 31 may be easily formed just by arranging a single linear member. The linear member may be made of various materials including metals, for example. When an electrically conductive material is used for the linear member, an insulating process, e.g., zinc plating or nickel plating, is performed on the surface of the electrically conductive material. Also, by using a material having high thermal conductivity, e.g., a Nichrome wire, as the linear member, such a material may be utilized to melt the solder 23. In the latter case, the solders 23 on the FPC terminal conductors 18-1 to 18-6 adjacent to each other may be selectively molten. Hence, the latter case is advantageous, for example, when a particular row of the terminal conductor is to be removed.

Instead of forming the projections 30 and the projections 31 on the FPC terminal portion 100-1 as described above, similar projections may be provided on the suspension terminal portion 14. Even in such a modification that the projections are provided on the suspension terminal portion 14, the appropriate standoff amount may be held between the FPC terminal portion 100-1 and the suspension terminal portion 14. Accordingly, the flow of the solders 23 is suppressed and the short-circuiting is prevented.

### Fifth Embodiment

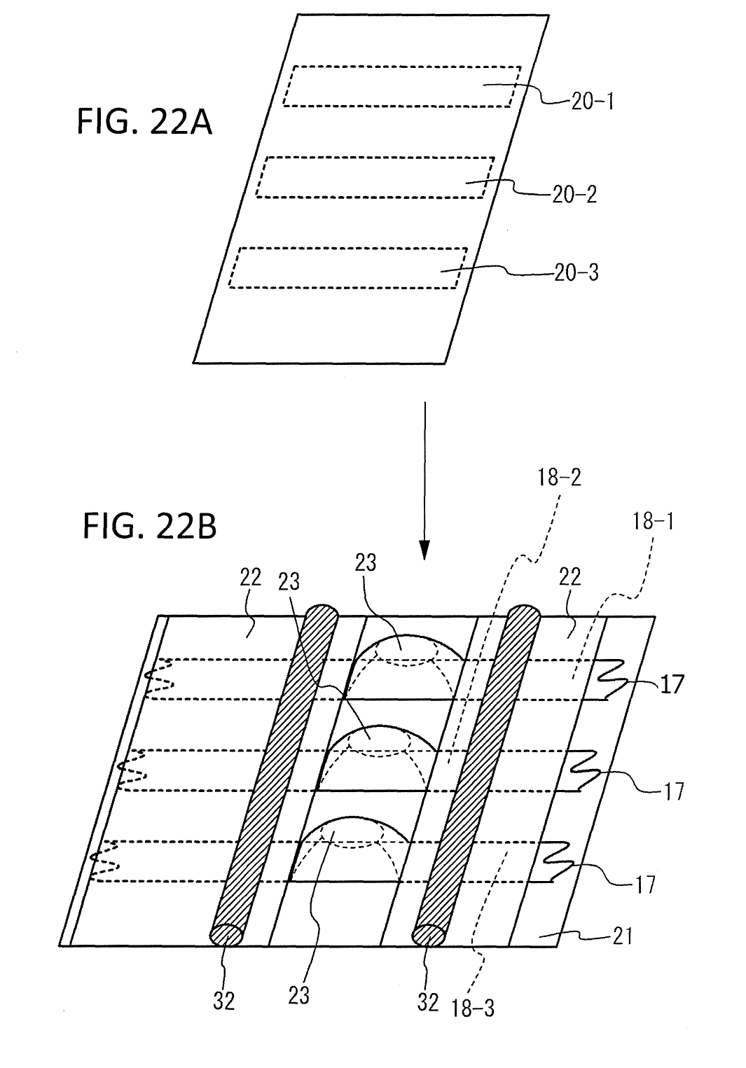

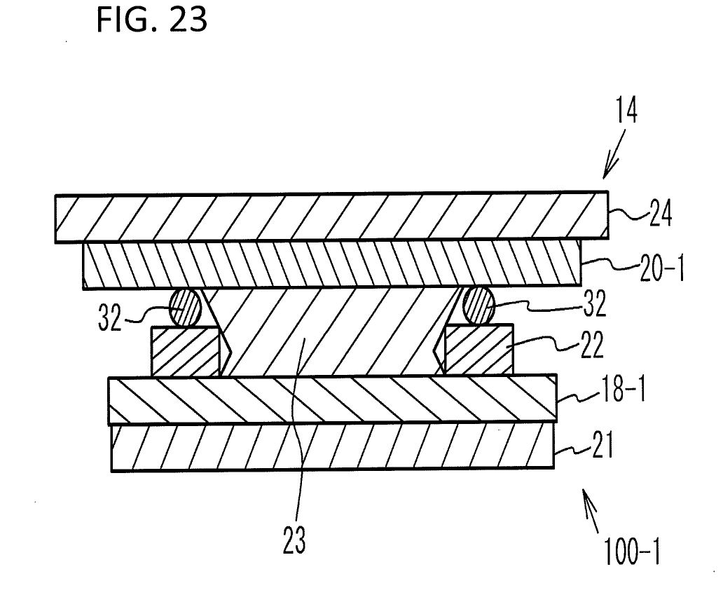

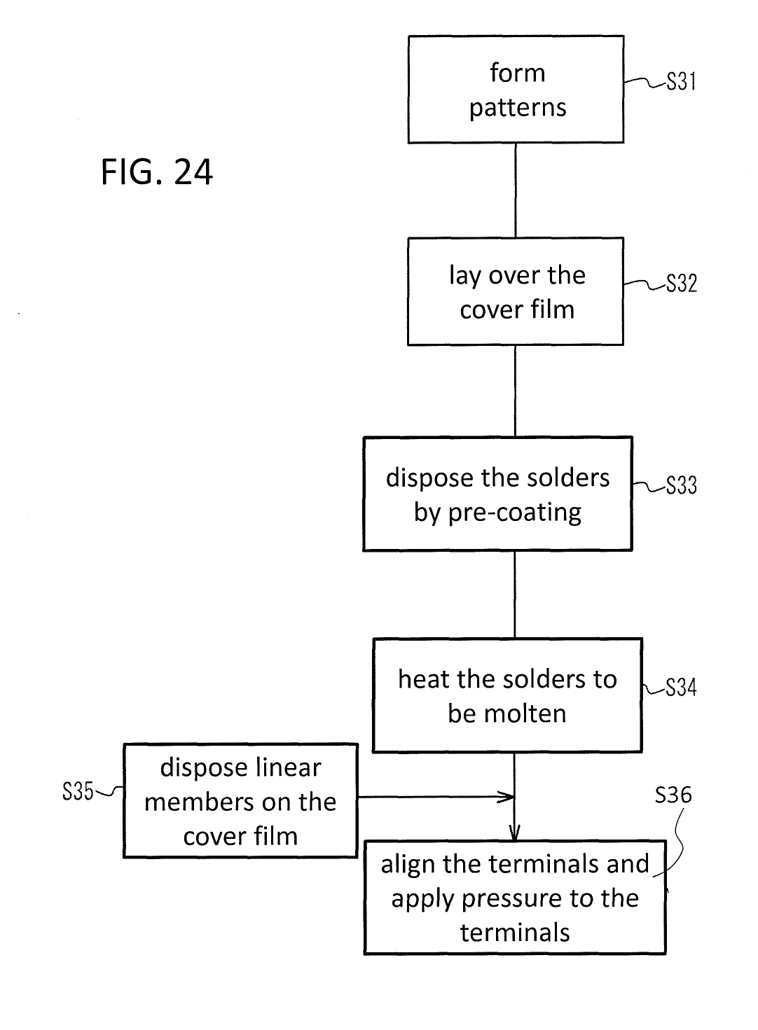

A fifth embodiment will be described below with reference to FIGS. 22 to 24. FIG. 22A is a perspective view illustrating, in schematic form, the suspension terminal portion 14 and FIG. 22B is a perspective view illustrating, in schematic form, an FPC terminal portion 100-1, according to the fifth embodiment, on which solders are pre-coated. FIG. 23 is an explanatory view illustrating a state where the FPC terminal portion 100-1 and the suspension terminal portion 14 are joined to each other by solder bonding. FIG. 24 illustrates steps of a solder bonding method according to the fifth embodiment. Be it noted that components in the fifth embodiment, which are common to those in the first embodiment, are denoted by the same reference numerals in the drawings and detailed descriptions of those components are omitted.

The fifth embodiment differs from the first embodiment in the following point. In the fifth embodiment, a linear member 32 representing one example of the gap adjusting member is disposed laterally of the solders 23 instead of the metal balls 25 in the first embodiment. The linear member 32 is disposed on the cover film 22. Although the linear member 32 is disposed on each of both sides of the solders 23 in the drawing, it may be disposed on only either side of the solders 23. The linear member 32 may be made of various materials including metals, for example. When an electrically conductive material is used for the linear member, an insulating process, e.g., zinc plating or nickel plating, is performed on the surface of the electrically conductive material. It is also effective to coat a heat-resistant resin on the surface of the electrically conductive material. Further, a heat-resistant resin, such as polyimide, may be alternatively used as the material of the linear member.

With the fifth embodiment described above, as with the first embodiment, the appropriate standoff amount is held between the FPC terminal portion 100-1 and the suspension terminal portion 14 as illustrated in FIG. 23. Accordingly, the flow of the solders 23 may be suppressed and the short-circuiting may be prevented.

The solder bonding method according to the fifth embodiment will be described below with reference to a step chart illustrated in FIG. 24.

First, in step S31, patterns are formed. The patterns are formed on both the FPC terminal portion 100-1 and the suspension terminal portion 14. More specifically, patterns including the FPC terminal conductors 18-1 to 18-6 and the wiring patterns 17 are printed on the base film 21 of the FPC terminal portion 100-1. On the other hand, patterns including the suspension terminal conductors 20-1 to 20-6 are printed on the base film 24 of the suspension terminal portion 14.

In such a manner, the FPC terminal conductors 18-1 to 18-6 and the suspension terminal conductors 20-1 to 20-6 are formed.

In step S32, the cover film 22 is laid over and stuck to (i.e., laminated on) the base film 21 of the FPC terminal portion 100-1.

In step S33, the solders 23 are disposed on parts of the FPC terminal conductors 18-1 to 18-6, which are exposed through the cover film 22. The solders 23 are disposed by pre-coating.

In step S34, the solders 23 are heated to be molten. Then, in step S35, the linear members 32 are disposed on the cover film 22. This step of disposing the linear members 32 on the cover film 22 represents one example of the step of providing means for suppressing flow of the solders in this specification. The step of disposing the linear members 32 on the cover film 22 may be performed at any timing during a period until pressure solder bonding between the FPC terminal portion 100-1 and the suspension terminal portion 14 (step S36) after the cover film 22 has been stuck.

After the end of step S35, the process advances to step S36. In step S36, the FPC terminal portion 100-1 and the suspension terminal portion 14 are positioned in opposite relation such that the FPC terminal conductors 18-1 to 18-6 and the suspension terminal conductors 20-1 to 20-6 are aligned with each other. Further, pressure is applied to between the FPC terminal portion 100-1 and the suspension terminal portion 14. As a result, they are joined to each other by pressure solder bonding.

At that time, since the linear members 32 are present between the FPC terminal portion 100-1 and the suspension terminal portion 14, the appropriate standoff amount is held between the FPC terminal portion 100-1 and the suspension terminal portion 14. Accordingly, the flow of the solders 23 is suppressed and the short-circuiting is prevented.

### Sixth Embodiment

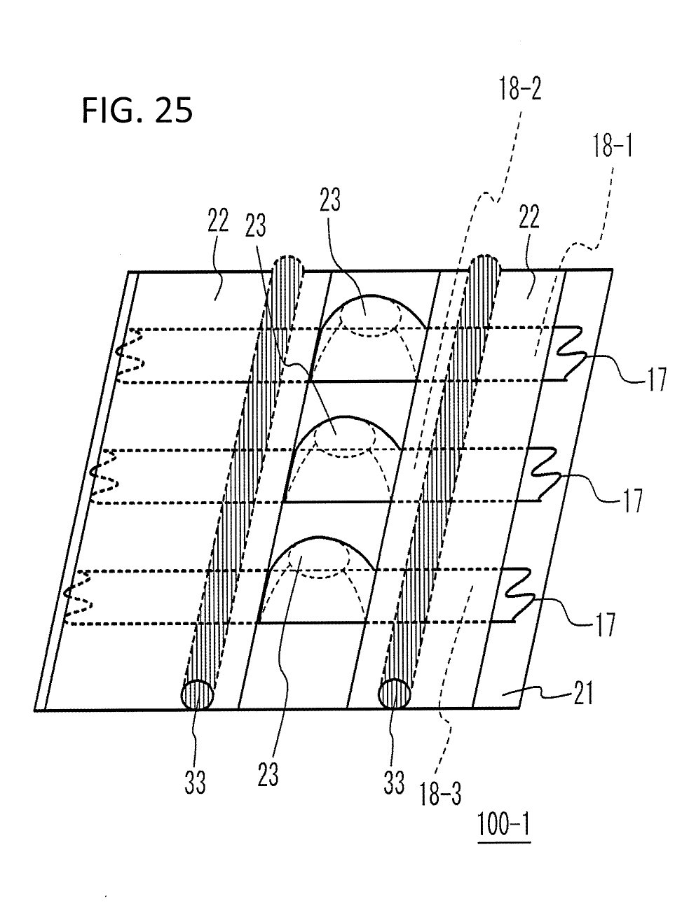

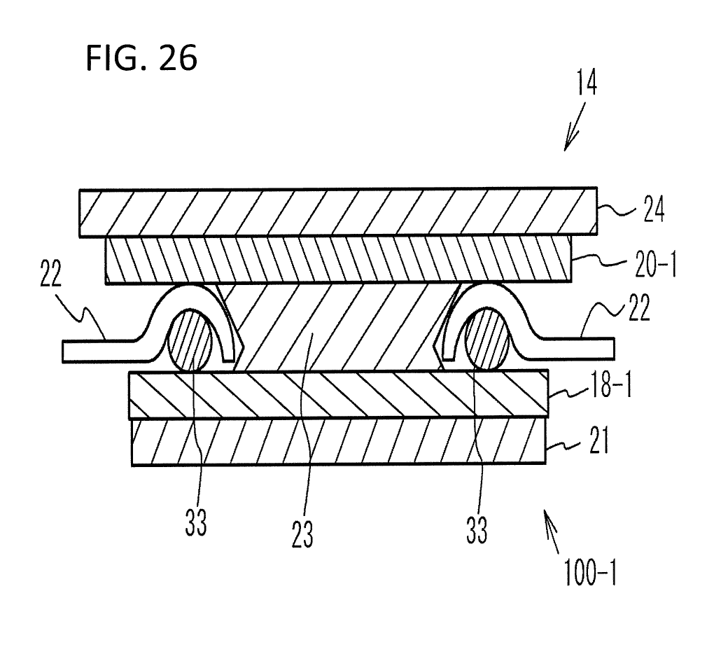

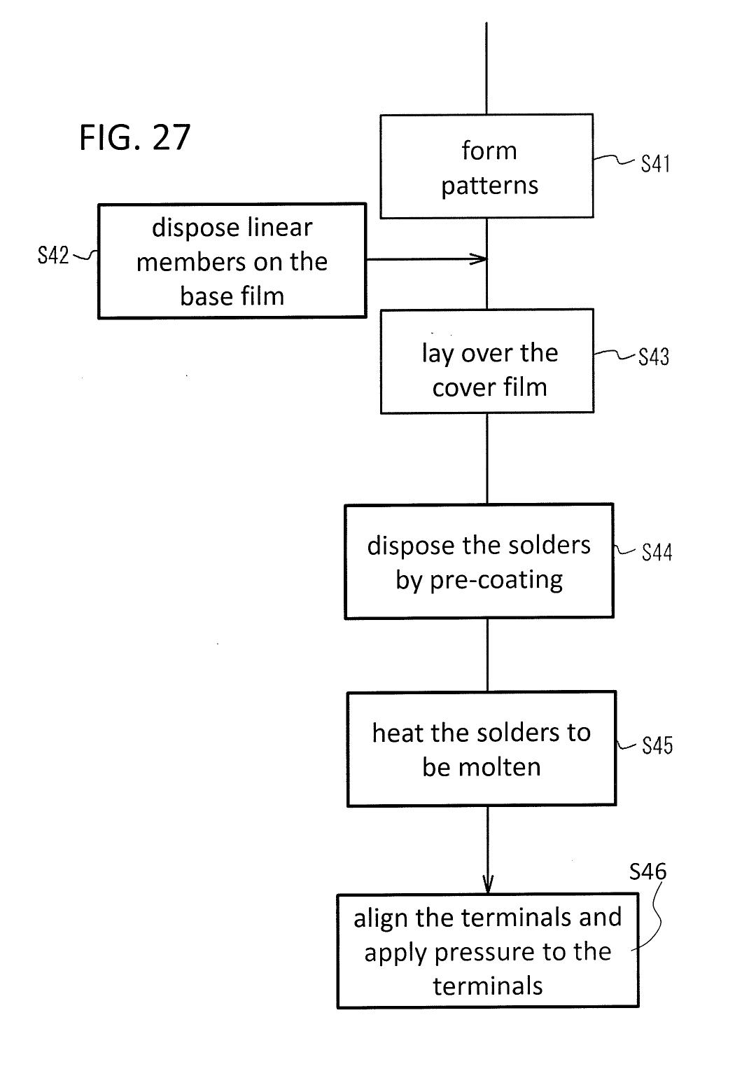

A sixth embodiment will be described below with reference to FIGS. 25 to 27. FIG. 25 is a perspective view illustrating, in schematic form, an FPC terminal portion 100-1, according to the sixth embodiment, on which solders are pre-coated. FIG. 26 is an explanatory view illustrating a state where the FPC terminal portion 100-1 and the suspension terminal portion 14 are joined to each other by solder bonding. FIG. 27 illustrates steps of a solder bonding method according to the sixth embodiment. Be it noted that components in the sixth embodiment, which are common to those in the first embodiment, are denoted by the same reference numerals in the drawings and detailed descriptions of those components are omitted.

The sixth embodiment differs from the first embodiment in the following point. In the sixth embodiment, a linear member 33 representing one example of the gap adjusting member is disposed laterally of the solders 23 instead of the metal balls 25 in the first embodiment. The linear member 33 is disposed between the base film 21 and the cover film 22, i.e., under the cover film 22. Such an arrangement of the linear member 32 differs from the fifth embodiment in which the linear member 32 is disposed on the cover film 22. Although the linear member 33 is disposed on each of both sides of the solders 23 in the drawing, it may be disposed on only either side of the solders 23. The linear member 33 may be made of various materials including metals, for example. When an electrically conductive material is used for the linear member, an insulating process, e.g., zinc plating or nickel plating, is performed on the surface of the electrically conductive material. It is also effective to coat a heat-resistant resin on the surface of the electrically conductive material. Further, a heat-resistant resin, such as polyimide, may be alternatively used as the material of the linear member.

With the sixth embodiment described above, as with the first embodiment, the appropriate standoff amount may be held between the FPC terminal portion 100-1 and the suspension terminal portion 14 as illustrated in FIG. 26. Accordingly, the flow of the solders 23 may be suppressed and the short-circuiting may be prevented.

The solder bonding method according to the sixth embodiment will be described below with reference to a step chart illustrated in FIG. 27.

First, in step S41, patterns are formed. The patterns are formed on both the FPC terminal portion 100-1 and the suspension terminal portion 14. More specifically, patterns including the FPC terminal conductors 18-1 to 18-6 and the wiring patterns 17 are printed on the base film 21 of the FPC terminal portion 100-1. On the other hand, patterns including the suspension terminal conductors 20-1 to 20-6 are printed on the base film 24 of the suspension terminal portion 14. In such a manner, the FPC terminal conductors 18-1 to 18-6 and the suspension terminal conductors 20-1 to 20-6 are formed. Then, in step S42, the linear members 33 are disposed on the base film 21. This step of disposing the linear members 33 on the base film 21 represents one example of the step of providing means for suppressing flow of the solders in this specification. The step of disposing the linear members 33 on the base film 21 may be performed before the patterns are formed.

In step S43, the cover film 22 is laid over and stuck to (i.e., laminated on) the base film 21 of the FPC terminal portion 100-1.

In step S44, the solders 23 are disposed on parts of the FPC terminal conductors 18-1 to 18-6, which are exposed through the cover film 22. The solders 23 are disposed by pre-coating.

In step S45, the solders 23 are heated to be molten. The process then advances to step S46. In step S46, the FPC terminal portion 100-1 and the suspension terminal portion 14 are positioned in opposite relation such that the FPC terminal conductors 18-1 to 18-6 and the suspension terminal conductors 20-1 to 20-6 are aligned with each other. Further, pressure is applied to between the FPC terminal portion 100-1 and the suspension terminal portion 14. As a result, they are joined to each other by pressure solder bonding.

At that time, since the linear members 33 are present between the FPC terminal portion 100-1 and the suspension terminal portion 14, the appropriate standoff amount is held between the FPC terminal portion 100-1 and the suspension terminal portion 14. Accordingly, the flow of the solders 23 is suppressed and the short-circuiting is prevented.

### Seventh Embodiment

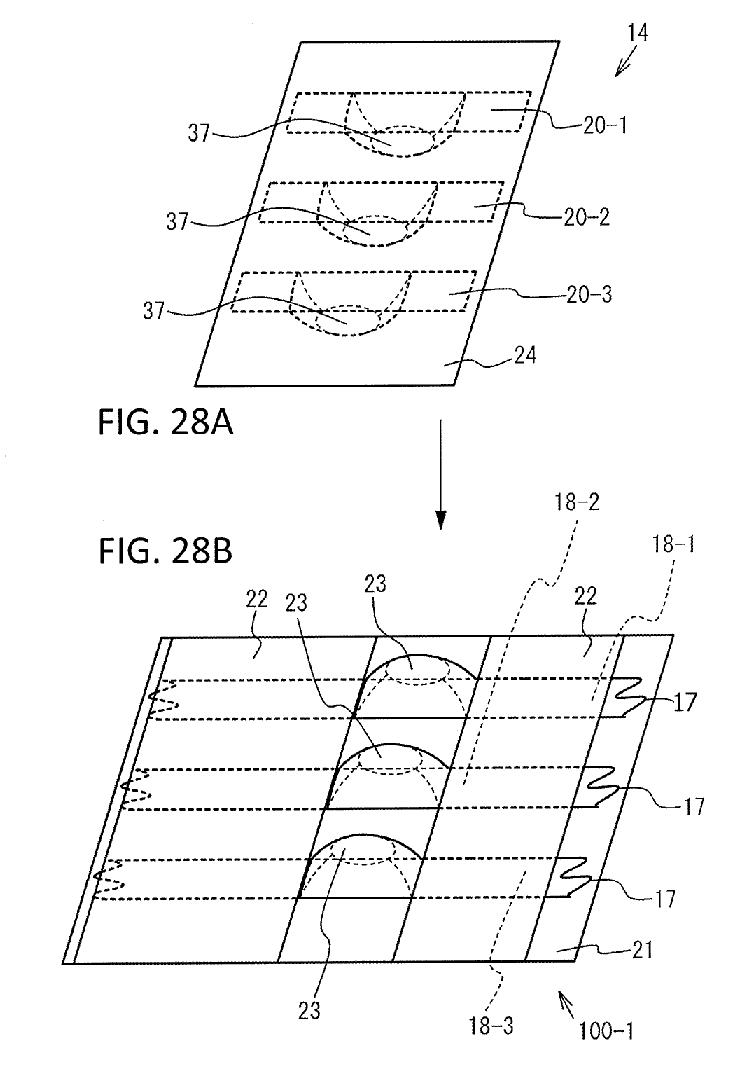

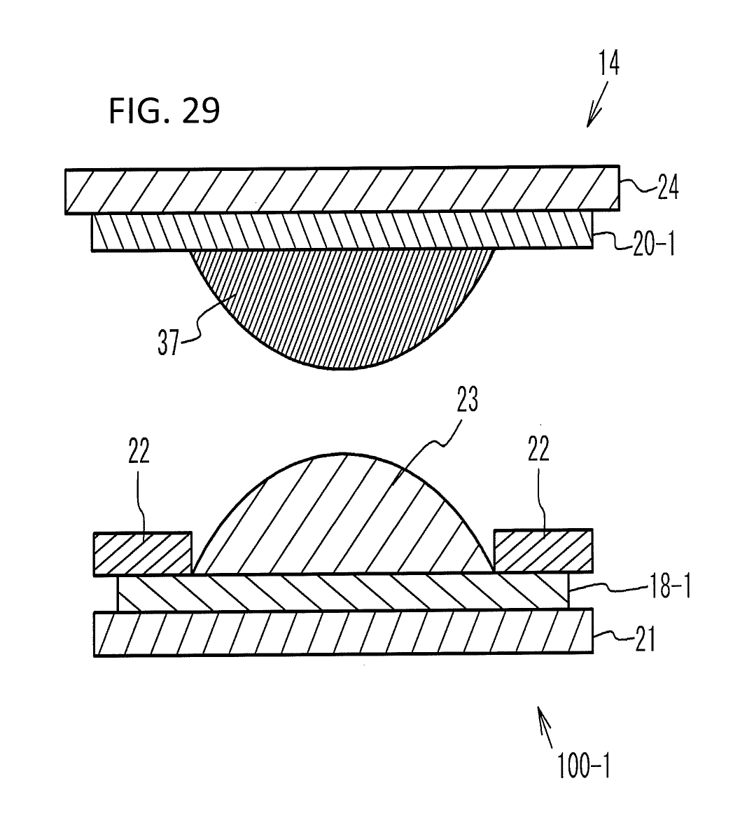

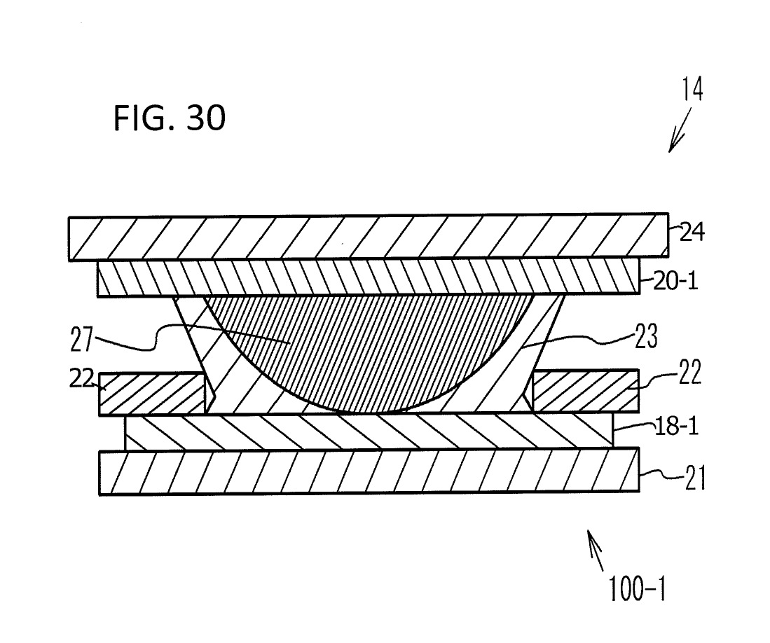

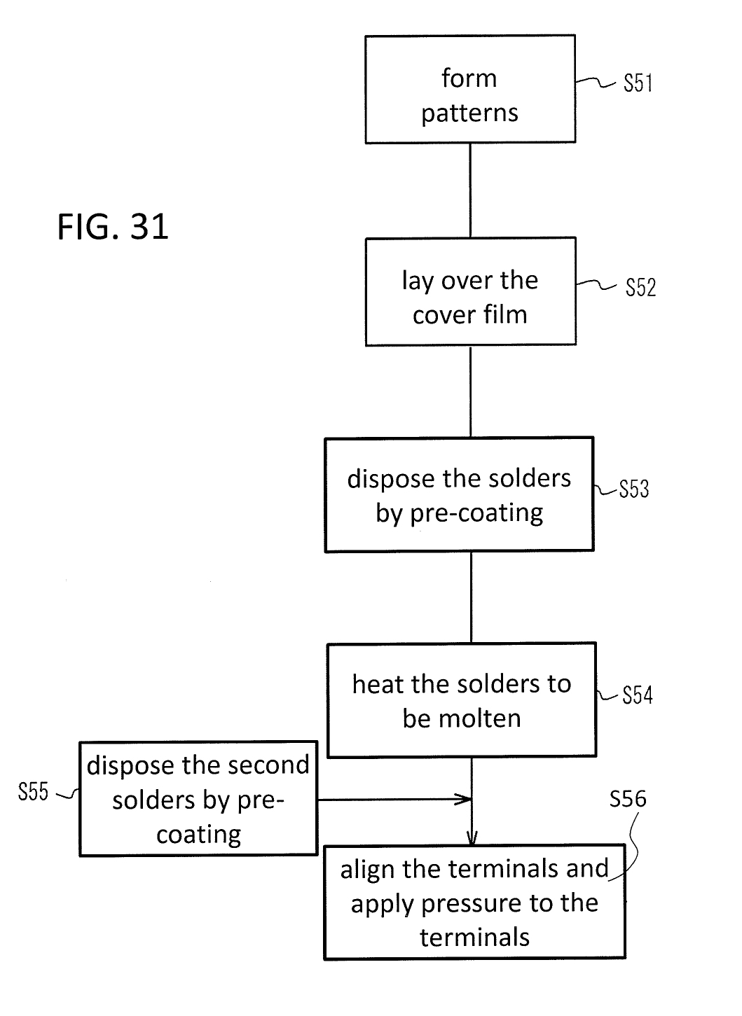

A seventh embodiment will be described below with reference to FIGS. 28 to 31. FIG. 28A is a perspective view illustrating, in schematic form, a suspension terminal portion 14 according to the seventh embodiment and FIG. 28B is a perspective view illustrating, in schematic form, an FPC terminal portion 100-1, according to the seventh embodiment, on which solders are pre-coated. FIG. 29 is an explanatory view illustrating, in schematic form, a state where the FPC terminal portion 100-1 on which the solders are pre-coated and the suspension terminal portion 14 are positioned opposite to each other. FIG. 30 is an explanatory view illustrating a state where the FPC terminal portion 100-1 and the suspension terminal portion 14 are joined to each other by solder bonding. FIG. 31 illustrates steps of a solder bonding method according to the seventh embodiment. Be it noted that components in the seventh embodiment, which are common to those in the first embodiment, are denoted by the same reference numerals in the drawings and detailed descriptions of those components are omitted.

The seventh embodiment differs from the first embodiment in the following point. In the seventh embodiment, second solders 37 are disposed on the suspension terminal portion 14 in addition to first solders 23 provided on the FPC terminal portion 100-1. Materials having different melting temperatures are selected for the first solders 23 and the second solders 37. In the seventh embodiment, the melting temperature of the first solders 23 is lower than that of the second solders 37. Therefore, it is possible to generate a state where the first solders 23 are molten, but the second solders 37 are not molten. The second solders 37 in the not-molten state represent one example of the solder flow suppressing means. Stated another way, each of the second solders 37 remaining without being molten may function as the gap adjusting member between the FPC terminal portion 100-1 and the suspension terminal portion 14. Conversely, the melting temperature of the first solders 23 may be set higher than that of the second solders 37.

Materials having lower melting temperatures may be, for example, Sn-58Bi (with melting temperature of 140° C. and “58” indicating percentage of Bi by weight) and Sn-52In (with melting temperature of 117° C. and “52” indicating percentage of In by weight). Materials having higher melting temperatures may be, for example, Sn-37Pb (with melting temperature of 183° C. and “37” indicating percentage of Pb by weight) and Sn-3.0Ag-0.5Cu (with melting temperature of 218° C., “3.0” indicating percentage of Ag by weight, and “0.5” indicating percentage of Cu by weight). Those materials may be optionally used as the first solders 23 and the second solders 37. Additionally, because the solder having higher melting temperature is not intended to be molten, it may be replaced with a projection formed by high-temperature plating.

With the seventh embodiment described above, as with the first embodiment, the appropriate standoff amount may be held between the FPC terminal portion 100-1 and the suspension terminal portion 14 as illustrated in FIG. 30. Accordingly, the flow of the solders 23 may be suppressed and the short-circuiting may be prevented.

The solder bonding method according to the seventh embodiment will be described below with reference to a step chart illustrated in FIG. 31.

First, in step S51, patterns are formed. The patterns are formed on both the FPC terminal portion 100-1 and the suspension terminal portion 14. More specifically, patterns including the FPC terminal conductors 18-1 to 18-6 and the wiring patterns 17 are printed on the base film 21 of the FPC terminal portion 100-1. On the other hand, patterns including the suspension terminal conductors 20-1 to 20-6 are printed on the base film 24 of the suspension terminal portion 14.

In such a manner, the FPC terminal conductors 18-1 to 18-6 and the suspension terminal conductors 20-1 to 20-6 are formed.

In step S52, the cover film 22 is laid over and stuck to (i.e., laminated on) the base film 21 of the FPC terminal portion 100-1.

In step S53, the first solders 23 are disposed on parts of the FPC terminal conductors 18-1 to 18-6, which are exposed through the cover film 22. The first solders 23 are disposed by pre-coating. Then, in step S54, the first solders 23 are heated to be molten.

Meanwhile, during a period until reaching step S54, the second solders 37 are pre-coated on the suspension terminal conductors 20-1 to 20-6 in step S55. In other words, the suspension terminal portion 14 is brought into such a state as illustrated in FIG. 29.

After the end of step S55, the process advances to step S56. In step S56, the FPC terminal portion 100-1 and the suspension terminal portion 14 are positioned in opposite relation such that the FPC terminal conductors 18-1 to 18-6 and the suspension terminal conductors 20-1 to 20-6 are aligned with each other. Further, pressure is applied to between the FPC terminal portion 100-1 and the suspension terminal portion 14. As a result, they are joined to each other by pressure solder bonding. When they are joined to each other by pressure solder bonding, the first solders 23 having the lower melting temperature are preferentially molten while metals are diffused to some extent from the second solders 23 having the higher melting temperature, thereby effectuating the solder bonding.

At that time, since the second solders 37 not completely molten are present between the FPC terminal portion 100-1 and the suspension terminal portion 14 as illustrated in FIG. 30, the appropriate standoff amount is held between the FPC terminal portion 100-1 and the suspension terminal portion 14. Accordingly, the flow of the first solders 23 is suppressed and the short-circuiting is prevented.

### Eighth Embodiment

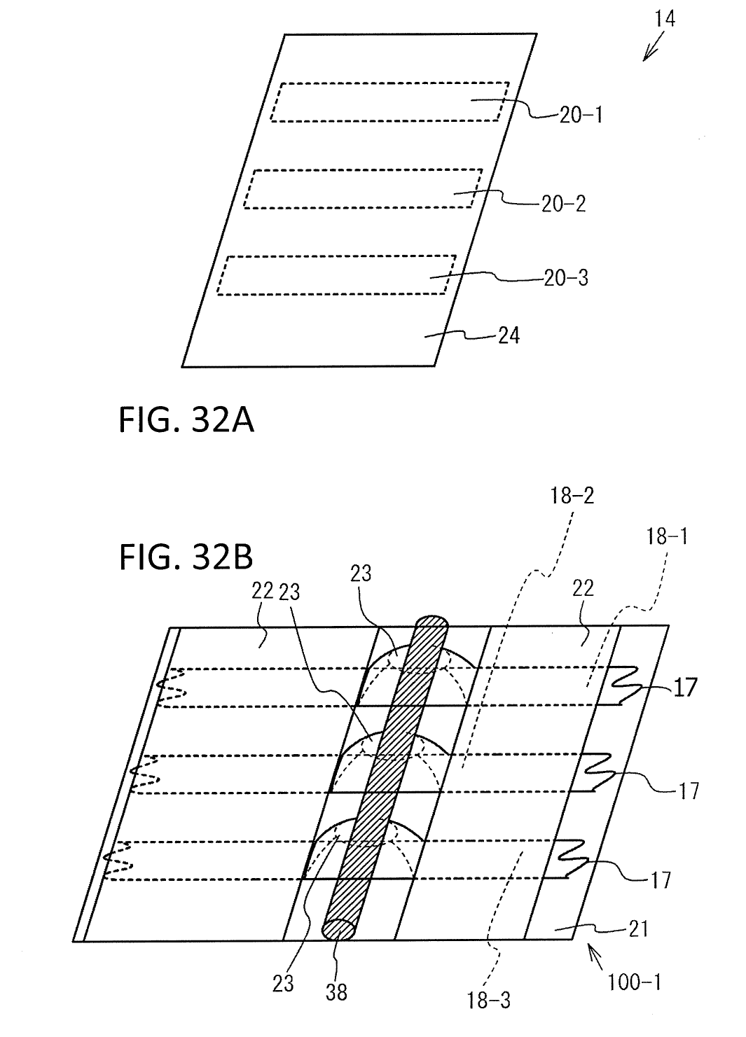

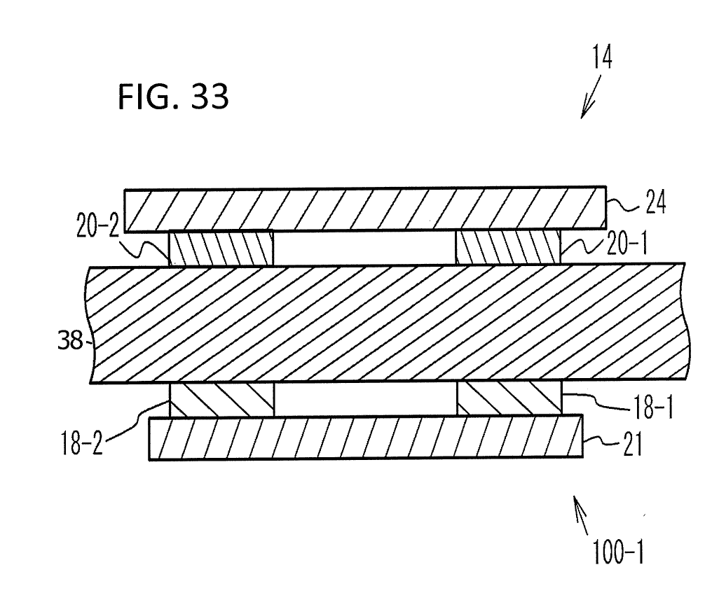

An eighth embodiment will be described below with reference to FIGS. 32A, 32B and 33. FIGS. 32A and 32B are perspective views illustrating, in schematic form, the suspension terminal portion 14 and an FPC terminal portion 100-1, according to the eighth embodiment, on which solders are pre-coated. FIG. 33 is an explanatory view illustrating a state where the FPC terminal portion 100-1 and the suspension terminal portion 14 are joined to each other by solder bonding. Be it noted that components in the eighth embodiment, which are common to those in the first embodiment, are denoted by the same reference numerals in the drawings and detailed descriptions of those components are omitted.

The eighth embodiment differs from the first embodiment in the following point. In the eighth embodiment, a linear member 38 representing one example of the gap adjusting member is disposed instead of the metal balls 25 in the first embodiment. The linear member 38 has thermal conductivity and its surface is subjected to an insulating process. Further, the linear member 38 is disposed so as to contact with the plural solders 23 which are disposed on the FPC terminal conductors 18-1 to 18-6, respectively. The linear member 38 differs from the linear member illustrated in FIG. 21 in such a point that it is positioned on the upper side of the FPC terminal conductors 18-1 to 18-6.

The linear member 38 may be made of various materials including metals, for example. When an electrically conductive material is used for the linear member, an insulating process, e.g., zinc plating or nickel plating, is performed on the surface of the electrically conductive material. It is also effective to coat a heat-resistant resin on the surface of the electrically conductive material.

The linear member 38 is placed on the solders 23 in a state extending along a row of the solders 23 when solder bonding is performed. After arranging the suspension terminal portion 14 onto the FPC terminal portion 100-1 including the solders 23 on which the liner member 38 is placed as mentioned above, both the terminal portions are joined to each other by the solder bonding while the linear member 38 is heated. By heating the linear member 38, the solders 23 may be preferentially and locally heated. As a result, thermal stresses imposed on surrounding areas and components near the FPC terminal conductors 18-1 to 18-6 may be lessened. Also, when the solder bonding is released, the solders 23 may be preferentially and locally heated in a similar way by heating the linear member 38. As a result, thermal damages of the surrounding components may be reduced and those components may be maintained in a reusable state. The linear member 38 may be heated by touching a soldering iron to the linear member 38 or supplying an electric current to the linear member 38.

With the eighth embodiment described above, as with the first embodiment, the appropriate standoff amount may be held between the FPC terminal portion 100-1 and the suspension terminal portion 14 as illustrated in FIG. 33. Accordingly, the flow of the solders 23 may be suppressed and the short-circuiting may be prevented.

### Ninth Embodiment

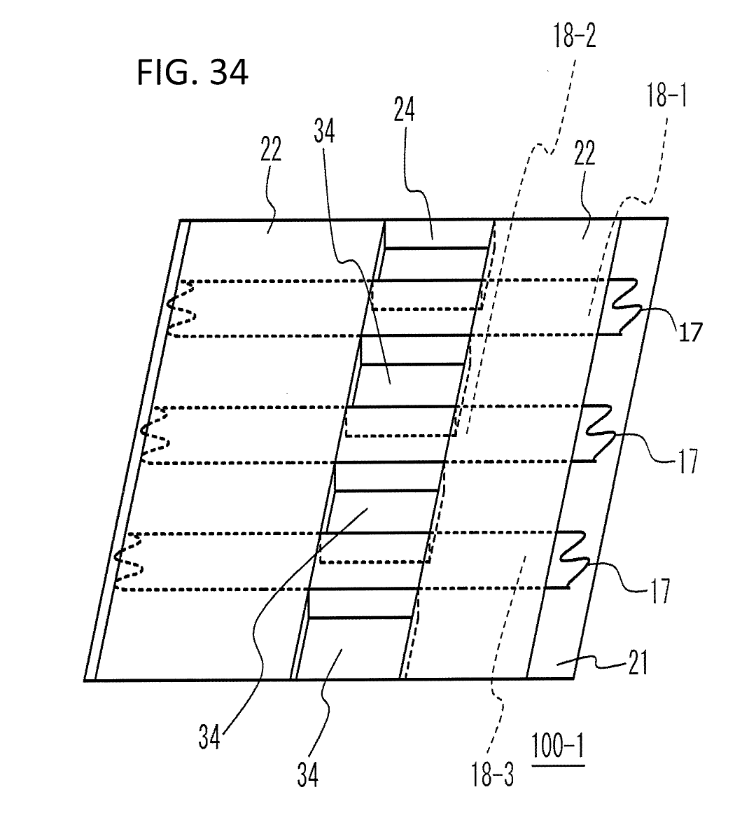

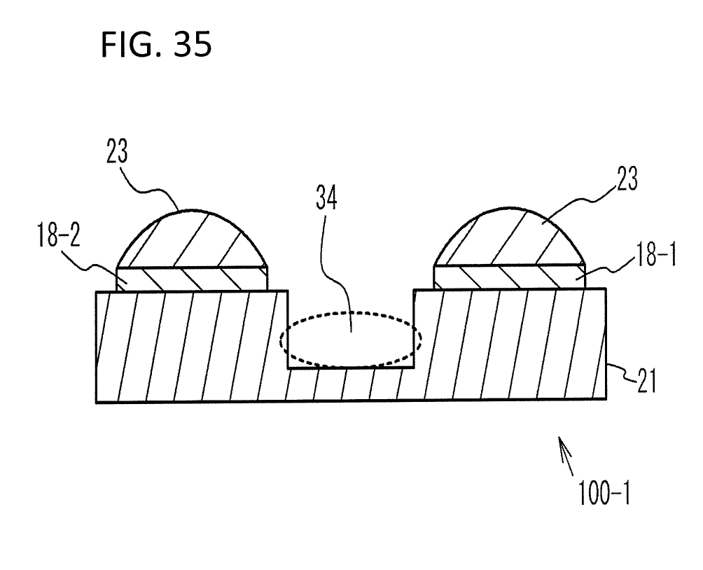

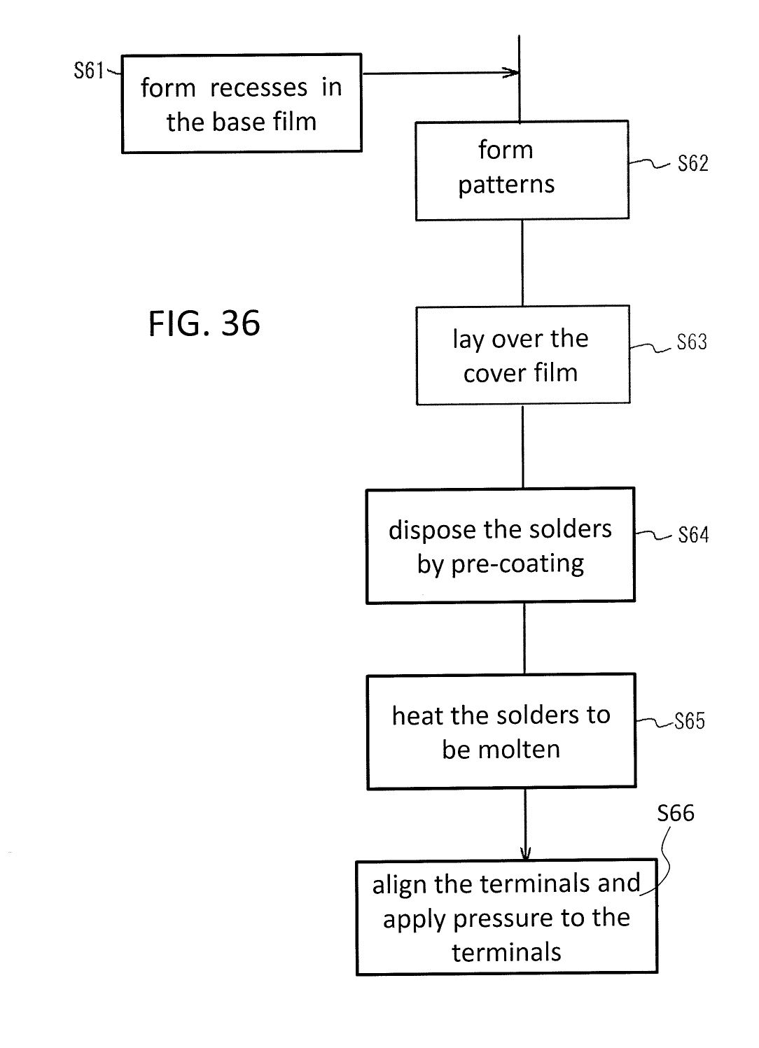

A ninth embodiment will be described below with reference to FIGS. 34 to 36. FIG. 34 is a perspective view illustrating, in schematic form, an FPC terminal portion 100-1, according to the ninth embodiment. FIG. 35 is a sectional view of the FPC terminal portion 100-1 illustrated in FIG. 34. Solder (bumps) 23 are illustrated in FIG. 35. FIG. 36 illustrates steps of a solder bonding method according to the ninth embodiment. Be it noted that components in the ninth embodiment, which are common to those in the first embodiment, are denoted by the same reference numerals in the drawings and detailed descriptions of those components are omitted.

In the ninth embodiment, unlike the first to eighth embodiments, recesses 34 are provided, as one example of the solder flow suppressing means, laterally of the FPC terminal conductors 18-1 to 18-6 instead of the gap adjusting member. As described above, the solders 23 are caused to flow when pressure is applied to between the FPC terminal portion 100-1 and the suspension terminal portion 14, which are arranged opposite to each other, such that both the terminal portions are pressed against each other, thus causing a risk of short-circuiting. The recesses 34 serve to capture and accommodate the solders 23 having flown, to thereby prevent short-circuiting between the terminal portions. The recesses 34 may be previously formed in the base film 21 as illustrated in FIG. 35.

The solder bonding method according to the ninth embodiment will be described below with reference to a step chart illustrated in FIG. 36.

First, in step S61, the recesses 34 are formed in the base film 21. This step of forming the recesses 34 represents one example of the step of providing means for suppressing flow of the solders in this specification. Then, in step S62, patterns are formed. The patterns are formed on both the FPC terminal portion 100-1 and the suspension terminal portion 14. More specifically, patterns including the FPC terminal conductors 18-1 to 18-6 and the wiring patterns 17 are printed on the base film 21 of the FPC terminal portion 100-1. On the other hand, patterns including the suspension terminal conductors 20-1 to 20-6 are printed on the base film 24 of the suspension terminal portion 14.

In such a manner, the FPC terminal conductors 18-1 to 18-6 and the suspension terminal conductors 20-1 to 20-6 are formed.

In step S63, the cover film 22 is laid over and stuck to (i.e., laminated on) the base film 21 of the FPC terminal portion 100-1.

In step S64, the solders 23 are disposed on parts of the FPC terminal conductors 18-1 to 18-6, which are exposed through the cover film 22. The solders 23 are disposed by pre-coating.

In step S65, the solders 23 are heated to be molten. After the end of step S65, the process advances to step S66. In step S66, the FPC terminal portion 100-1 and the suspension terminal portion 14 are positioned in opposite relation such that the FPC terminal conductors 18-1 to 18-6 and the suspension terminal conductors 20-1 to 20-6 are aligned with each other. Further, pressure is applied to between the FPC terminal portion 100-1 and the suspension terminal portion 14. As a result, they are joined to each other by pressure solder bonding.

At that time, since the recesses 34 are provided laterally of the FPC terminal conductors 18-1 to 18-6, the solders 23 having flown are captured in the recesses 34 and are avoided from further flowing toward the surroundings. Accordingly, the short-circuiting is prevented.

### Tenth Embodiment

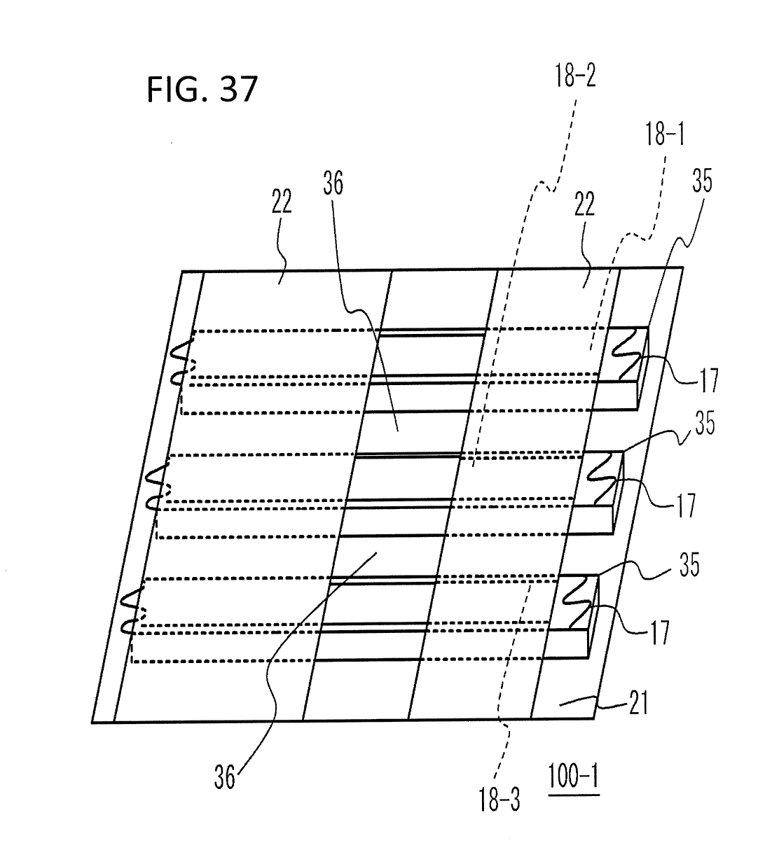

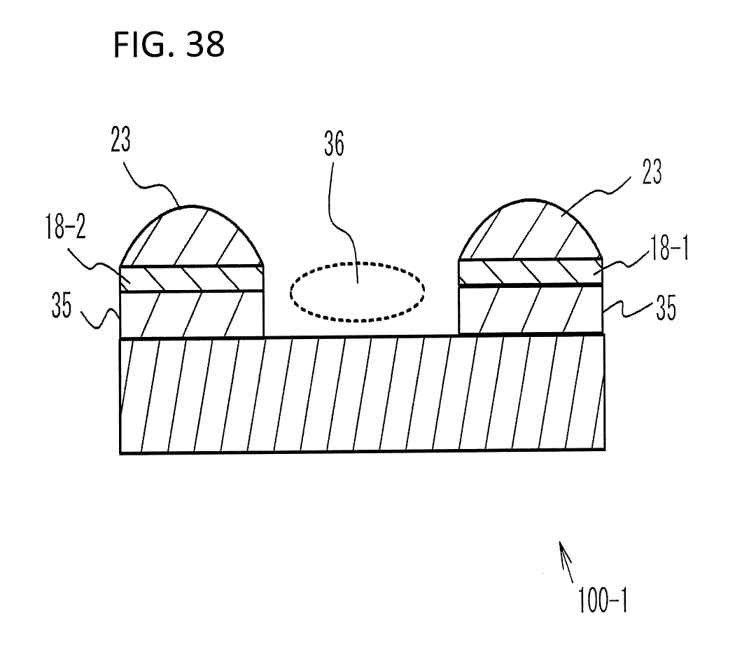

A tenth embodiment will be described below with reference to FIGS. 37 and 38. FIG. 37 is a perspective view illustrating, in schematic form, an FPC terminal portion 100-1, according to the tenth embodiment. FIG. 38 is a sectional view of the FPC terminal portion 100-1 illustrated in FIG. 37. Solder (bumps) 23 are illustrated in FIG. 35. Be it noted that components in the tenth embodiment, which are common to those in the first embodiment, are denoted by the same reference numerals in the drawings and detailed descriptions of those components are omitted.

The tenth embodiment differs from the ninth embodiment in the following point. In the tenth embodiment, recesses 36 are provided instead of the recesses 34 in the ninth embodiment. The recesses 36 are formed by arranging plate-like spacers 35 on the base film 21. The FPC terminal conductors 18-1 to 18-6 are formed on the spacers 35, respectively.

The recesses 36 in the tenth embodiment are able to, as with the recesses 34 in the ninth embodiment, capture the solders 23 having flown and to avoid the solders 23 from further flowing toward the surroundings. Accordingly, the short-circuiting may be prevented.

While the preferred embodiments of the present invention have been fully described above, the present invention is not limited to those particular embodiments and may be variously modified or altered without departing from the scope of the present invention, which is defined in claims.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a depicting of the superiority and inferiority of the invention. Although the embodiments of the present invention have been described in detail, it should be understood that the various changes, substitutions, and alterations could be made hereto without departing from the spirit and scope of the invention.

What is claimed is:

1. A solder joint structure comprising:
a first terminal portion including a plurality of first terminal conductors adjacent to each other;
a second terminal portion arranged opposite to the first terminal portion and including a plurality of second terminal conductors which are joined to the first terminal conductors;
solders electrically connecting the first terminal conductors and the second terminal conductors; and
member for suppressing flow of the solders.

2. The solder joint structure according to claim 1, wherein the member for suppressing flow of the solder is a gap adjusting member disposed between the first terminal portion and the second terminal portion which are arranged opposite to each other.

3. The solder joint structure according to claim 1, wherein the member for suppressing flow of the solder is a gap adjusting member disposed in the solder.

4. The solder joint structure according to claim 1, wherein the member for suppressing flow of the solder is a projection formed on each of surfaces of the first terminal conductors and/or the second terminal conductors.

5. The solder joint structure according to claim 1, wherein the member for suppressing flow of the solder is a projection formed by partly raising each of the first terminal conductors and/or the second terminal conductors.

6. The solder joint structure according to claim 1, wherein the member for suppressing flow of the solder is a gap adjusting member disposed laterally of the solders.

7. The solder joint structure according to claim 1, wherein the member for suppressing flow of the solder is provided by one of a first solder disposed on the first terminal portion and a second solder disposed on the second terminal portion, which has a higher melting temperature.

8. The solder joint structure according to claim 1, wherein the member for suppressing flow of the solder is a gap adjusting member which has thermal conductivity, which has a surface subjected to an insulating process, and which is arranged in contact with the solders disposed respectively on the first terminal conductors.

9. The solder joint structure according to claim 1, wherein the member for suppressing flow of the solder is a recess formed laterally of each of the first terminal conductors and/or the second terminal conductors.

10. An electronic device including a solder joint structure, wherein the solder joint structure comprises:
a first terminal portion including a plurality of first terminal conductors adjacent to each other;
a second terminal portion arranged opposite to the first terminal portion and including a plurality of second terminal conductors which are joined to the first terminal conductors;
solders electrically connecting the first terminal conductors and the second terminal conductors; and
member for suppressing flow of the solders.

11. A solder bonding method comprising the steps of:
forming first terminal conductors on a first terminal portion;
forming second terminal conductors on a second terminal portion;
disposing solders on the first terminal conductors and/or the second terminal conductors;
providing members for suppressing flow of the solders;
melting the solders; and
joining the first terminal portion and the second terminal portion, which are arranged in opposite relation, to each other by pressure solder bonding.
